(19) United States
(12) Patent Application Publication
(10) Pub. No.: US 2026/0231212 A1
(43) Pub. Date: Aug. 6, 2026

(54) ADAPTATION OF SL SYNCHRONIZATION SOURCE BASED ON CCA FAILURES

(71) Applicant: Telefonaktiebolaget LM Ericsson (publ), Stockholm (SE)

(72) Inventors: Santhan Thangarasa, Vällingby (SE); Muhammad Kazmi, Sundbyberg (SE)

(21) Appl. No.: 19/150,448

(22) PCT Filed: Feb. 16, 2024
(86) PCT No.: PCT/IB2024/051515

§ 371 Date: Jul. 23, 2025

Related U.S. Application Data
(60) Provisional application No. 63/446,267, filed on Feb. 16, 2023.

(51) Int. Cl. H04W 74/0816; H04W 74/08; H04W 92/18

(52) U.S. Cl. CPC H04W 74/0816; H04W 74/0891; H04W 92/18

(57) ABSTRACT

Systems and methods for adaptation of sidelink (SL) synchronization source based on Clear Channel Assessment (CCA) failures are disclosed. In some embodiments, a method for selecting and/or maintaining a synchronization source includes: obtaining information about one or more synchronization sources associated with sidelink operation, including a configured synchronization source and/or available synchronization sources; for a first synchronization source, determining whether to adapt selecting and/or maintaining of the first synchronization source as a source of synchronization, based on a CCA procedure; and adapting the selecting and/or maintaining. In some embodiments, a method for operating as a synchronization reference UE includes: obtaining information related to need for transmitting SL reference signal (RS); determining information related to a result of a CCA procedure; and adapting transmission of a SL RS based on the result of the CCA procedure. Some embodiments: enable selection of reliable synchronization sources; and/or define clear synchronization procedure for sidelink.

### RELATED APPLICATIONS

This application claims the benefit of provisional patent application Ser. No. 63/446,267, filed Feb. 16, 2023, the disclosure of which is hereby incorporated herein by reference in its entirety.

### TECHNICAL FIELD

V2X, D2D, Sidelink, UE-to-Network relay, Proximity-Based Service (ProSe), LBT, CCA, unlicensed band operation, synchronization reference resource.

### BACKGROUND

### Unlicensed Operation in NR

The unlicensed spectrum can be shared between multiple networks. A device/node prior to transmission on a channel on an unlicensed spectrum performs a Clear Channel Assessment (CCA) to assess or determine whether the channel is busy or not. The CCA procedure is also called listen before talk (LBT).

A CCA consists of monitoring the channel for a certain specified time and measuring the received energy and/or in some technologies (e.g., Wi-Fi) checking for preamble transmission indicating the beginning of another device's transmission. The device is allowed to transmit signals on the channel provided that the channel is assessed (e.g., based on CCA) to be idle, which may also be called a clear channel, free channel, available channel, unused channel or channel not busy. The channel is assessed to be idle provided that the received energy or power during the sensing time duration is below a certain energy detection threshold; otherwise, the channel is considered to be busy. The example of energy detection level threshold is −72 dBm, which may further depend on the channel bandwidth e.g., −72 dBm and −75 dBm for 20 MHz and 10 MHz respectively. If the channel is assessed as “busy” then the device (UE or BS) is required to defer transmission.

After sensing the channel to be idle, the device/node is typically allowed to transmit for a certain amount of time, sometimes referred to as the Channel Occupancy Time (COT) or Maximum Channel Occupancy Time (MCOT). The maximum allowed length of the COT depends on regulation and type of CCA (e.g., for how long time the medium was sensed e.g., sensing duration) that has been performed—The COT typically ranges between 1 ms and 10 ms.

FIG. 1 shows LTE LBT and COT, where “s” is the sensing time period. In one example the sensing period can be 25 μs. In this figure, if the channel is determined to be busy, after some deferral time the device may try again to sense on the channel in order to determine whether the channel is available, and if so after some backoff time the device may start transmitting signal (during the device's channel occupancy time) but for no longer than the maximum channel occupancy time (MCOT) which can be e.g., up to 10 ms, depending on the region. The backoff time may be deterministic or statistical.

### SideLink Transmission in NR

The sidelink (SL) operation enables direct communication on the SL or PC5 interface between two or more UEs.

The D2D operation is a generic term which may comprise transmission and/or reception of any type of D2D signals (e.g., physical signals, physical channel etc.) by a D2D communication capable UE and/or by D2D discovery capable UE. V2X is a special type of device to device (D2D) operation. D2D operation is therefore also called as D2D transmission, D2D reception, D2D communication, proximity services (ProSe), V2X, etc.

The SL operation is specified for LTE and NR for variety of applications and use cases e.g., Proximity Services (ProSe) (communication and discovery), vehicular communications (commonly referred to as V2X or V2V) etc. In LTE V2X only broadcast is supported over sidelink. The NR SL is capable of broadcast, groupcast, and unicast communications. In groupcast communication, the intended receivers of a message are typically a subset of the vehicles near the transmitter, whereas in unicast communication, there is a single intended receiver. Broadcast, groupcast, and unicast transmissions for V2X operation on the SL are supported for the in-coverage, out-of-coverage and partial-coverage scenarios. For unicast and groupcast transmissions on SL, HARQ feedback and HARQ combining in the physical layer of the UE are supported.

Both the LTE SL and the NR SL can operate with and without network coverage and with varying degrees of interaction between the UEs (user equipment) and the network), including support for standalone, network-less operation.

The SL can be configured on a dedicated carrier (e.g., in a carrier of ITS band) or a carrier of the serving cell of the UE. In the latter case the SL resources and resources for cellular communication (over uplink/downlink, also known as Uu link) are shared in time and/or frequency. Typically, the SL resources are time multiplexed with the uplink resources used for cellular communication on the serving cell of the UE.

The embodiments described herein are applicable for any type of D2D operation including ProSe, V2X and so on.

Examples of physical channels and reference signals for SL operation NR (available in LTE before) are:
PSSCH (Physical Sidelink Shared Channel, SL version of PDSCH): The PSSCH is transmitted by a sidelink transmitter UE, which conveys sidelink transmission data, system information blocks (SIBs) for radio resource control (RRC) configuration, and a part of the sidelink control information (SCI).
PSFCH (Physical Sidelink feedback channel): The PSFCH is transmitted by a sidelink receiver UE for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.

DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Similar as for ProSe in LTE, NR sidelink transmissions have the following two modes of resource allocations: Mode 1: Sidelink resources are scheduled by a gNB. Mode 2: The UE autonomously selects sidelink resources from a (pre-) configured sidelink resource pool(s) based on the channel sensing mechanism.

For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2.

As captured in the RP-213678 on NR SL evolution in 3GPP Rel-18, the following study objective has been defined for 3GPP Rel-18
1. Study and specify support of sidelink on unlicensed spectrum for both mode 1 and mode 2 where Uu operation for mode 1 is limited to licensed spectrum only [RAN1, RAN2, RAN4]
   Channel access mechanisms from NR-U shall be reused for sidelink unlicensed operation
      Assess the applicability of sidelink resource reservation from Rel-16/Rel-17 to sidelink unlicensed operation within the boundaries of unlicensed channel access mechanism and operation
         No specific enhancements for Rel-17 resource allocation mechanisms.
         If the existing NR-U channel access framework does not support the required SL-U functionality, WGs will make appropriate recommendations for RAN approval.
   Physical channel design framework: Required changes to NR sidelink physical channel structures and procedures to operate on unlicensed spectrum
      The existing NR sidelink and NR-U channel structure shall be reused as the baseline.
   No specific enhancements for existing NR SL feature
   The study should focus on FR1 unlicensed bands (n46 and n96/n102) and is to be completed by RAN #98.

In order to support sidelink transmission on unlicensed spectrum (SL-U), new mechanism for selecting and maintaining reliable synchronization source is needed since the legacy mechanism is not designed to cope with the LBT failures both at the transmitting and receiving node. Following the legacy mechanism for performing the synchronization procedure on unlicensed spectrum may result in UE selecting less reliable synchronization sources which eventually leads to connection failure. Therefore, new synchronization methods are needed to support sidelink operation on unlicensed spectrum.

### SUMMARY

Systems and methods for adaptation of sidelink (SL) synchronization source based on Clear Channel Assessment (CCA) failures are disclosed. In some embodiments, a method performed by a User Equipment (UE) for selecting and/or maintaining a synchronization source includes: obtaining information about one or more synchronization sources associated with sidelink operation, the one or more synchronization sources comprising a configured synchronization source and/or available synchronization sources; for a first synchronization source of the one or more synchronization sources associated with the sidelink operation, determining whether to adapt selecting and/or maintaining of the first synchronization source as a source of synchronization, the determining based on at least one CCA procedure; and in response to determining to adapt the selecting and/or maintaining of the first synchronization source as the source of synchronization based on the at least one CCA procedure, adapting the selecting and/or maintaining of the first synchronization source as the source of synchronization. In some embodiments, a method performed by a UE for operating as a synchronization reference UE includes: obtaining information related to need for transmitting SL reference signal (RS); determining information related to a result of at least one CCA procedure associated with SRS; and adapting transmission of a SL RS based on the result of the at least one CCA procedure. Some embodiments provide one or more benefits such as: enabling Selection of reliable synchronization sources when operating in carrier subject to CCA; and/or defining clear synchronization procedure for sidelink when operating in carrier subject to CCA.

Some embodiments described herein apply to a scenario where UE1 is configured to operate (e.g., transmit and/or receive) signals between UE1 and at least one other UE, a second UE (UE2) on a second carrier (F2). UE1 and UE2 can be operating in either sidelink mode 1 or mode 2. UE1 is further configured with a list of synchronization sources or follows a list of synchronization sources (e.g., predefined in the specification) to select a synchronization reference source, where the sources may have same or different priorities.

In a first embodiment, UE1 synchronized to a first synchronization reference source (SRS1) for using a signal transmitted on a first carrier frequency (F1) by SRS1 for a sidelink operation, determines a result of a CCA procedure performed by SRS1 for transmitting signals on F1 and adapts the synchronization reference source (SRS) based on the determined result of the CCA procedure performed by SRS1 on a signal transmitted on F1.

The adaptation of the SRS may be determined by UE1 based on one or more rules which may be pre-defined, pre-configured (e.g., on SIM/USIM card), or configured by a node (e.g., by another UE, a network etc.). Examples of the adaptation of the SRS are continue using SRS1, discarding SRS1, changing/reselecting the synchronization to a second synchronization reference source (SRS2), suspending SRS1 for a period of time, suspending or postponing SRS1 until one or more conditions are met, initiating/ceasing of SLSS, etc. Examples of the results of the CCA procedures are: number of CCA failures, number of successful CCA, number of CCA failures over a time period, number of successful CCA over a time period etc. For example, UE1 triggers reselection of synchronization reference source (e.g., to SRS2) if the number of CCA failures on F1 detected by UE1 exceeds a threshold; otherwise, the UE continues using SRS1. The signals received from SRS1, whose transmissions are subject to CCA procedure, are used by UE1 to adjust, correct or obtain timing information to be able to operate SL signals on F1. SRS1 can be a UE, a third UE (UE3) or a first network node (NN1 e.g., a first base station). SRS2 can be a UE, a fourth UE (UE4) or a second network node (NN2 e.g., a second base station).

In a second embodiment, a third UE (UE3) configured as a first synchronization reference source (SRS1) for at least one other UE, a first UE (UE1) on a first carrier (F1), determines a result of a CCA procedure performed by UE3 on F1 and adapts a transmission of a SL reference signals (SLRS) on F1 based on the determined result of the CCA procedure performed by UE3 on F1.

The adaptation of the SLRS transmission may be determined by UE3 based on one or more rules which may be pre-defined, pre-configured (e.g., on SIM/USIM card), or configured by a node (e.g., by another UE, a network etc.). Examples of the adaptation of the SLRS are continuing transmission of the SLSS, stopping/ceasing the transmission of the SLRS, suspending or postponing the transmission of the SLRS for a period of time or resuming/re-initiating SLRS transmission after a period of time, suspending or postponing the transmission of the SLRS until one or more conditions are met or resuming/re-initiating SLRS transmission after one or more conditions are met, adapting the transmission rate of the SLRS (e.g., transmitting the SLRS with a rate below threshold) etc. An example of SLRS is SLSS. Examples of the results of the CCA procedures are: number of CCA failures, number of successful CCA, number of CCA failures over a time period, number of successful CCA over a time period etc. For example, UE3 stops/ceases the SLRS transmission if the number of CCA failures on F1 detected by UE3 exceeds a threshold; otherwise UE3 continues transmission of SLRS. UE3 typically transmits periodic SL reference signals (e.g., SLSS).

The operation between UE1 and UE2 on F2 may or may not be subject to CCA procedure i.e., CCA procedure is applied before transmission of the signals. However, the operation between UE1 and SRS1 is subject to CCA. In one example, F1 and F2 are different carrier frequencies. In another example, F1 and F2 are the same carrier frequency.

The terms synchronization reference source, synchronization sources, and synchronization references are used herein interchangeably.

Some embodiments provide one or more benefits such as: enabling Selection of reliable synchronization sources when operating in carrier subject to CCA; and/or defining clear synchronization procedure for sidelink when operating in carrier subject to CCA.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows LTE LBT and COT, where “s” is the sensing time period;

FIG. 2 illustrates one example of a cellular communications system according to some embodiments of the present disclosure;

FIG. 3 illustrates scenarios in which UE1 engaged in SL operation with UE2, obtaining timing from a first synchronization reference sources (SRS1), which is subject to CCA;

FIG. 4 illustrates scenarios in which UE1 changes/reselects its SRS from SRS1 to SRS2 due to CCA failures on F1 between UE1 and SRS1;

FIG. 5 is a schematic block diagram of a radio access node according to some embodiments of the present disclosure;

FIG. 6 is a schematic block diagram that illustrates a virtualized embodiment of the radio access node of FIG. 5 according to some embodiments of the present disclosure;

FIG. 7 is a schematic block diagram of the radio access node of FIG. 5 according to some other embodiments of the present disclosure;

FIG. 8 is a schematic block diagram of a User Equipment device (UE) according to some embodiments of the present disclosure;

FIG. 9 is a schematic block diagram of the UE of FIG. 8 according to some other embodiments of the present disclosure;

FIG. 10 illustrates a telecommunication network connected via an intermediate network to a host computer in accordance with some embodiments of the present disclosure;

FIG. 11 is a generalized block diagram of a host computer communicating via a base station with a UE over a partially wireless connection in accordance with some embodiments of the present disclosure;

FIG. 12 is a flowchart illustrating a method implemented in a communication system in accordance with one embodiment of the present disclosure;

FIG. 13 is a flowchart illustrating a method implemented in a communication system in accordance with one embodiment of the present disclosure;

FIG. 14 is a flowchart illustrating a method implemented in a communication system in accordance with one embodiment of the present disclosure; and

FIG. 15 is a flowchart illustrating a method implemented in a communication

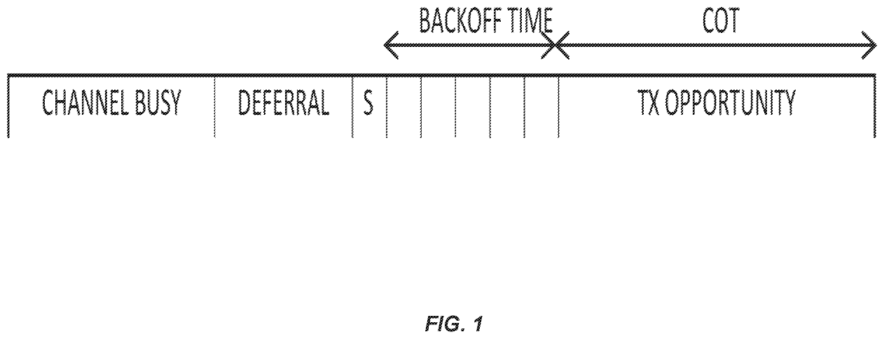

system in accordance with one embodiment of the present disclosure.

### DETAILED DESCRIPTION

The embodiments set forth below represent information to enable those skilled in the art to practice the embodiments and illustrate the best mode of practicing the embodiments.

Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include but are not limited to: a User Equipment device (UE) in a 3GPP network, a Machine Type Communication (MTC) device, and an Internet of Things (IoT) device.

Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may be a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

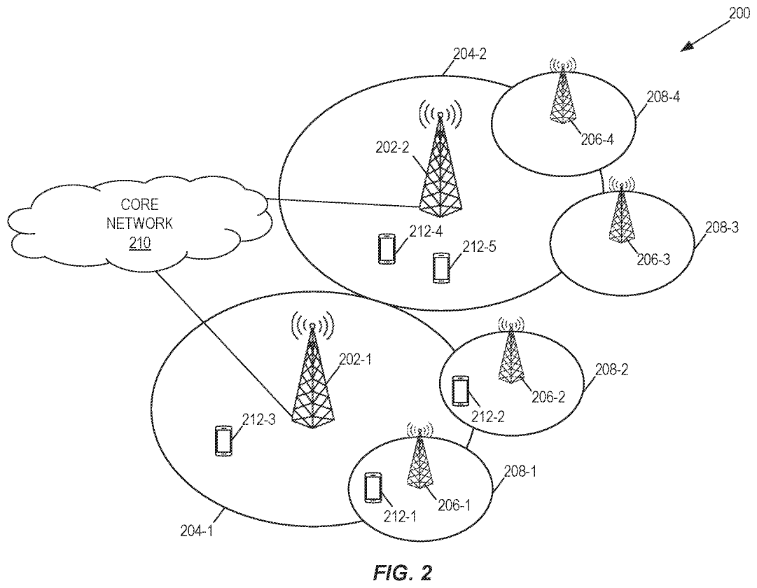

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC). In this example, the RAN includes base stations 202-1 and 202-2, which in the 5GS include NR base stations (gNBs) and optionally next generation eNBs (ng-eNBs) (e.g., LTE RAN nodes connected to the 5GC), controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or RRHs, or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5G System (5GS) is referred to as the 5GC. The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs, but the present disclosure is not limited thereto.

### Generalization and Terminology

Examples of network nodes are NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, transmission reception point (TRP), RRU, RRH, nodes in distributed antenna system (DAS), core network node (e.g., MSC, MME etc.), O&M, OSS, SON, positioning node (e.g., E-SMLC), etc.

The non-limiting term UE refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), USB dongles etc.

The term radio access technology, or RAT, may refer to any RAT e.g., UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term clear channel assessment (CCA) used herein may correspond to any type of carrier sense multiple access (CSMA) procedure or mechanism which is performed by the device on a carrier before deciding to transmit signals on that carrier. The term carrier may also be interchangeably called as carrier frequency, frequency layer, a channel, a radio channel, a radio frequency channel etc. The CCA is also interchangeably called CSMA scheme, channel assessment scheme, listen-before-talk (LBT), shared channel access mechanism or scheme, shared spectrum channel access mechanism or scheme etc. The frequency band of a carrier subject to CCA may also be called as unlicensed band or spectrum, shared spectrum channel access band, band for operation with shared spectrum channel access etc. The CCA based operation is more generally called contention-based operation. The transmission of signals on a carrier subjected to CCA is also called contention-based transmission. The contention-based operation is typically used for transmission on carriers of unlicensed frequency band. But this mechanism may also be applied for operating on carriers belonging to licensed bands, for example to reduce interference. The transmission of signals on a carrier which is not subjected to CCA is also called contention free transmission. LBT or CCA procedure can be performed by UE prior to UL transmission) and/or by a network node (e.g., base station) prior to DL transmission or by another SL UE. Therefore, CCA may also be called as DL CCA (e.g., performed before DL transmission), UL CCA (e.g., performed before UL transmission) etc.

The term SLRS used in the different embodiments are referred to any of: SL-SSSB, SLSS, S-PSS, S-SSS, PSBCH or any combination e.g., S-SS/PSBCH (S-SS+S-PSS+PSBCH).

In addition, both LBE based channel access schemes (may also be named as dynamic channel access) and FBE based channel access schemes (may also be named as semi static channel access) are covered in the following embodiments.

The following embodiments are applicable to SL transmissions on unlicensed band with any cast type including unicast, groupcast and broadcast.

For a SL BWP configured to the UE, the BWP may contain multiple bandwidth segments referred to as e.g., channel, sub-band, BWP segment etc., for each segment, it may be configured with the following different parameters: SCS, Symbol duration, Cyclic prefix (CP) length.

In this case, the UE may perform LBT operation per channel/subband/BWP segment.

The term “operation of the signal” may refer to any of: transmission of the signal by the device and/or reception of the signal at the device. The term “operation of the signal being subject to CCA” may refer to a scenario in which the device before transmitting a signal of a carrier may apply CCA procedure to decide whether the channel is idle or busy i.e., device transmits signal if the channel is idle otherwise it defers the transmission. For simplicity in some embodiments a term, “carrier subject to CCA” may be used, referring to the operation of signal on cells of the carrier when the CCA procedure is applied by the device before transmission of the signal. Each occurrence of the signal or the occurrence when the UE can operate the signal is broadly called as an occasion, which may be transmission occasion or a reception occasion. The occasion is also interchangeably called as signal occasion, signal operational occasion, measurement occasion, signal operational opportunity, signal duration, operational occasion or simply occasion for operating a signal etc. Examples of occasions are time resources containing RS (e.g., SLSS, CSI-RS, SSB), SMTC occasion, discovery burst transmission (DBT) window etc. An occasion may occur once every RS periodicity (e.g., once every SMTC period), once every DRX cycle, every Q^{th} DRX cycle (where Q>1) etc.

### Scenario

The embodiments are described in the context of NR, i.e., two or more SL UEs operate in or served by a same cell or different cells or one or more SL UEs are out of network coverage. However, the embodiments are applicable to LTE or any other technology (e.g., 6th generation system) that enables the direct connection between two (or more) devices. The embodiments are also applicable to relay scenarios including UE to network relay or UE to UE relay where the remote UE and the relay UE may be based on LTE sidelink or NR sidelink, the Uu connection between the relay UE and the base station may be LTE Uu or NR Uu.

The scenario comprises UE1 which is configured to operate (e.g., transmit and/or receive) signals with at least another UE (UE2) on a second carrier frequency (F2). In one example, the SL operation between UE1 and UE2 on F2 is subject to CCA procedure i.e., CCA procedure is applied before transmission of the signals. In another example, the SL operation between UE1 and UE2 on F2 is NOT subject to CCA procedure i.e., no CCA procedure is applied before transmission of the signals. When the operating SL UEs are in coverage, the UE can either operate in mode 1 or mode 2. The main difference between the two modes is that SL transmissions are scheduled by the network node in mode 1 while they are autonomously scheduled/selected by the UEs in mode 2.

The UEs involved in sidelink communication are further (pre) configured with a list of synchronization sources (e.g., predefined in the specification), where the sources may have same or different priorities. An example of list of synchronization sources comprising GNSS, UE or network node (e.g., gNB, eNB, BS etc.) is shown below in their priority order. P0 is of highest priority while P6 is of lowest priority.

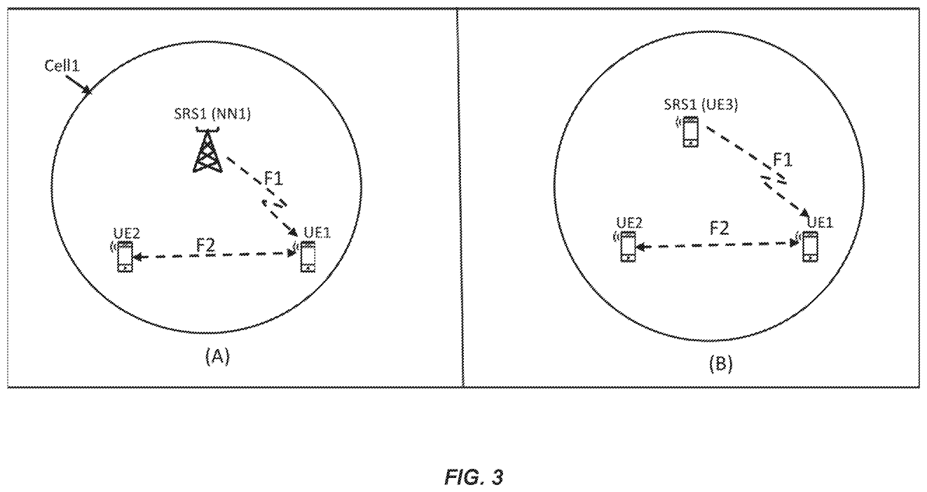

An example, in FIG. 3 illustrates a scenario considered in some of the embodiments. FIG. 3 illustrates scenarios in which UE1 engaged in SL operation with UE2, obtaining timing from a first synchronization reference sources (SRS1), which is subject to CCA: A) SRS1 is a first network node (NN1); B) SRS1 is a third UE (UE3). The figure shows that UE1 is engaged in SL operation with UE2 on F2. The figure shows that UE1 obtains the time synchronization with respect to a first synchronization reference sources (SRS1) operating on F1, which is subject to CCA e.g., on a carrier belonging to unlicensed band. In one example as shown in FIG. 3 (A), SRS1 is a first network node (NN1) e.g., base station, eNB, gNB, access point etc. In another example as shown in FIG. 3 (B), SRS1 is another UE e.g., a third UE (UE3). In some embodiments F1 and F2 are different carrier frequencies operating on the same or different frequency bands. In some embodiments F1 and F2 are the same carrier frequencies i.e., F1=F2. In this case, the radio links (or signals) between UE1 and UE2, and between UE1 and SRS1 may be orthogonal with respect to each other in time domain and/or in frequency domain.

List of synchronization sources for sidelink

| GNSS-based | gNB/eNB-based |
|---|---|
| P0: GNSS | P0′: gNB/eNB |
| P1: UE directly synchronized to GNSS | P1′: UE directly synchronized to |
| | gNB/eNB |
| P2: UE indirectly synchronized to GNSS | P2′: UE indirectly synchronized to gNB/eNB |
| P3: gNB/eNB | P3′: GNSS |
| P4: UE directly synchronized to | P4′: UE directly synchronized to GNSS |
| gNB/eNB | |
| P5: UE indirectly synchronized to gNB/eNB | P5′: UE indirectly synchronized to GNSS |
| P6: the remaining UEs have the lowest | P6′: the remaining UEs have the lowest priority |
| priority | |

Systems and methods for adaptation of SL synchronization source based on CCA failures are disclosed. In some embodiments, a method performed by a UE for selecting and/or maintaining a synchronization source includes: obtaining information about the configured synchronization source and/or the available synchronization sources; determining whether there is a need for adapting SRS based on at least one CCA procedure; and in response to determining that there is a need for adapting SRS, performing the adaptation of SRS. In some embodiments, a method performed by a UE for operating as a synchronization reference UE includes: obtaining information related to need for transmitting SL RS; determining information related to a result of at least one CCA procedure associated with SRS; and adapting transmission of a SL RS based on the result of the at least one CCA procedure. Some embodiments provide one or more benefits such as: enabling Selection of reliable synchronization sources when operating in carrier subject to CCA; and/or defining clear synchronization procedure for sidelink when operating in carrier subject to CCA.

Embodiment 1: Methods in the UE1 for selecting and maintaining synchronization source. The embodiments described herein can be implemented in any combination. The UE embodiment comprises at least the following: Step 1: UE1 obtains information about the configured synchronization source and/or the available synchronization sources. Step 2: UE1 determines need for adapting SRS based on the at least CCA procedure. Step 3: UE1 performs the adaptation of SRS, which meets the criteria.

Step 1: UE1 obtaining information about SRS

In this step, the UE1 obtains information about the configured, supported or available synchronization reference sources (SRS). In one example the UE1 may obtain information about the SRS based on a message received from the network node e.g., configuration via signaling such as via RRC, DCI or MAC-CE. For example, a set of SRS may be pre-defined and UE1 may select one SR, a first SRS (SRS1) from the set of predefined SRS based on the received identifiers from the network node. For example, if the UE1 is configured with identifier P1 in the above table assuming gNB/eNB based synchronization configuration, then the UE1 selects or uses gNB/eNB as synchronization reference source. On the other hand, if UE1 is configured with identifier P3′ then UE1 uses GNSS as the synchronization reference source, etc.

In another example, the set of SRSs may be pre-defined and the UE1 selects one SRS from the set of SRSs based on one or more rules. The set of SRSs in the set may have different priorities as shown in the table above. In one example, the rules are associated with UE's operating scenarios (e.g., in-coverage, out-of-coverage or partial coverage) etc.

In another example, UE1 selects a SRS based on the type of carrier where the SL is operated. For example, UE1 may select P0 (GNSS) if SL operation is on a carrier subject to CCA but it may use P0′ (gNB/eNB) if the SL operation is on a carrier not subject to CCA or on carrier where UE1 is also performing the WAN operation e.g., on the Uu interface etc. In another example, if SL operation on F2 between UE1 and UE2 is on a carrier subject to CCA then UE1 also selects SRS (e.g., another UE or base station) also on a carrier which is subject to CCA.

In yet another example, UE1 selects the SRS based on the availability of the SRS type in the predefined list. For example, UE1 first attempts to use P0/P0′ as the SRS but if it is not available or detectable then it tries to select P1/P1′ etc.

Step 2: UE1 Determines Information Related to Result of CCA Procedure Associated with SRS

In this step, the UE1 determines information related to result of CCA procedure based on one or more rules or parameters related to CCA failures associated with the signals transmitted by the first SRS (SRS1) on F1. The term CCA failures, CCA procedures or information related to CCA procedures, or rules related to CCA procedures are interchangeably used. The said rules may be pre-defined, preconfigured (e.g., on SIM/USIM card) or configured by a node (e.g., by another UE, a network node etc.).

Examples of parameters related to the CCA procedures include:

### Results of the CCA Procedure

The results of the CCA procedure can be expressed in terms of CCA failures determined by UE1 on a radio link between UE1 and SRS1 operating on F1. In one example, UE1 autonomously determines or detects a CCA failure by detecting the absence of the signals transmitted by SRS1 on the radio link or by detecting that the signal quality of the signals transmitted by SRS1 is below certain threshold. In another example, UE1 determines or detects a CCA failure by receiving information from another node. For example, UE1 may receive from the network node (e.g., serving BS) information about the number of CCA failures occurred on signals which were to be transmitted by SRS1.

For example, UE1 compares results of the CCA procedure performed on F1 with a certain threshold over certain time period and based on this comparison determines whether the CCA procedure related criterion is met or not.

In one example CCA results may be expressed in terms of number (N) of CCA failures determined by UE1 on a radio link (e.g., PC5 link between UE1 and SRS1) during certain time period (T0). The number of the CCA failures determined during T0 may be contiguous or non-contiguous in time.

In another example, the CCA results may also be or alternatively be expressed in terms of number of successful CCA determined by UE1 on a radio link on F1 during certain time period (T0). The number of the successful CCA determined during T0 may be contiguous or non-contiguous in time.

A CCA failure during an occasion may also be expressed as unavailability of signal (e.g., reference signal (RS)) at the UE1 during that occasion. In one example N corresponds to number of RS occasions (e.g., SSB, SMTC, CSI-RS, SLSS, SL-SSB, SL-SMTC occasions) not transmitted by SRS1 on F1 during T0 due to UL CCA failure. In another example N corresponds to number of RS occasions (e.g., SSB, SMTC, CSI-RS, SLSS, SL-SSB, SL-SMTC occasions) not available at the UE1 in the cell during T0. In one example N corresponds to number of DRX cycles each with at least one RS occasion (e.g., SSB, SMTC, CSI-RS, SLSS, SL-SSB, SL-SMTC occasions) is not transmitted by SRS1 on F1 due UL CCA failure during T0. In another example N corresponds to number of DRX cycles each with at least one RS occasion (e.g., SSB, SMTC, CSI-RS, SLSS, SL-SSB, SL-SMTC occasions) not available at the UE1 during T0. The term RS occasion not available at the UE1 may further refer to when the RS occasion (e.g., SSB, SMTC, CSI-RS, SLSS, SL-SSB, SL-SMTC occasions) contains RS configured by the SRS1 on a carrier frequency (e.g., F1) is subject to CCA.

Maximum allowed number (Nₘₐₓ) of CCA failures on F1 during T0. Nₘₐₓ may further depend on one or more parameters. Nₘₐₓ may be pre-defined or configured by the network node. Examples of the parameters are DRX cycle length, eDRX cycle length, periodicity of a reference signal (TRS) (e.g., SSB periodicity, SMTC periodicity, CSI-RS periodicity, SLSS periodicity, SL-SMTC periodicity, etc.). For example, Nₘₐₓ=8 for DRX cycle length (T_{DRX})<1.28 s and Nₘₐₓ=4 for T_{DRX}≥1.28 s.

Relation between N and Nmax. Examples of the relations are ratio, comparison (e.g., greater than, equal to or less than etc.). For example, whether, N>Nmax, N=Nmax, N<Nmax etc.

Number (K) of times UE has determined that N exceeded Nₘₐₓ. In one example, K is determined over a certain time period (T01).

Examples of adaptation of SRS when UE1 meets one or more of the criteria associated with CCA procedures are described below section.

### Step 3: UE1 Adapting the SRS Based on the Result of CCA Procedure

In this step, the UE1 adapts one or more procedures related to or involving the SRS based on the result of CCA procedure as determined in previous step. Examples of different types of adaptations performed by UE1 with respect to the SRS based on the results of the CCA comprise as follows:

### Continue Using SRS1,

In one example of the adaption, UE1 continues using SRS1 as the synchronization reference source. For example if the results of CCA procedures reveal no CCA failures or limited number of CCA failures then UE1 may continue using SRS1 as the synchronization reference source for sidelink operation on F1. In one specific example, if (N<Nmax) during a certain time period (e.g., T0) then UE1 continues to use SRS as the synchronization source. Otherwise, UE1 may perform any of the other adaptations listed below (such as discarding SRS1, reselecting SRS, suspending SRS1 etc.). In one example, Nmax=1 and in another example, Nmax>1.

Discarding, suspending or postponing SRS1 for a period of time Tn,

In another example of the adaption, UE1 discards, suspends or postpones using SRS1 as the synchronization reference source for a certain time period of time. UE1 may further resume using SRS1 as the synchronization reference source after that time period or it may discard SRS1. For example if the results of CCA procedures show CCA failures or high number of CCA failures (e.g., number of CCA failures is above a threshold), then it may discard, suspend or postpone using SRS1 as the synchronization reference source for a period of time Tn.

In one specific example, if (N>Nmax) occurs R1 number of times during a certain time period (e.g., T0) then the UE1 discards SRS1 as the synchronization source. Otherwise, UE1 may continue to use SRS1 as the synchronization source.

In another example, UE1 discards SRS1 as the synchronization source when it has exceeded the maximum allowed CCA failures (Nmax) more than K number of times. Otherwise, it may continue to use SRS1 as the synchronization source.

During the time UE1 discards, suspends or postpones SRS1, UE1 may fallback to a reference synchronization source (RSS) which may be predefined, preconfigured or configured by the network node e.g., serving BS. Examples of such fallback RSS include UE1's internal clock, using the GNSS timing during the time period (Tn) SRS1 is suspended, postponed or delayed.

During the time UE1 discards, suspends or postpones SRS1, UE1 may or may not perform SL operation with respect to UE2. In one example, UE1 may still perform SL operation with respect to UE2 until certain time period, which may be pre-defined or configured by another node (e.g., a UE, a network node etc.).

Suspending or postponing SRS1 until one or more conditions are met, etc.

After suspending or postponing use of SRS1 as the synchronization sources for a time period, UE1 may resume using SRS1 as the synchronization source when one or more conditions are met, e.g., when N1 number of CCA evaluations has succeeded. In one specific example, the UE resumes using SRS1 as the synchronization source when it has detected that at least Z1 consecutive number of CCA was successful. In another specific example, the UE resumes using SRS1 as the synchronization source when it has detected that at least Z2 number of CCA was successful over certain time period. The Z2 number of CCA may be consecutive or non-consecutive.

In another example, UE1 may resume using SRS1 as the synchronization source when it has performed a reselection to a new cell. The new cell may operate on the same carrier frequency as that of the current/old serving cell or it may operate on a new carrier frequency. In another example, UE1 may resume using SRS1 as the synchronization source when it has performed a reselection to a new cell which also operates on a new carrier frequency (i.e., changed the carrier frequency e.g., from F1 to F2). F2 may or may not be subject to CCA.

During the time UE1 suspends or postpones SRS1, UE1 may or may not perform SL operation with respect to UE2. In one example, UE1 may still perform SL operation with respect to UE2 until certain time period, which may be pre-defined or configured by another node (e.g., a UE, a network node etc.).

Changing/reselecting the synchronization reference source to a second synchronization reference source (e.g., SRS2),

If the results of CCA procedures indicate CCA failures or high number of CCA failures on F1 for a period of time Tn (e.g., number of CCA failures is above a threshold over certain time period), then the UE may reselect (i.e., starts using a new synchronization reference source) another synchronization source (e.g., SRS2).

In one specific example, if (N>Nmax) occurs K number of times then UE1 performs the reselection of SRS (from SRS1 to SRS2). Otherwise, it may continue using SRS1 as the synchronization source. K≥1. In one example, K=1.

In another specific example, if (N>Nmax) occurs R1 number of times during a certain time period (e.g., T0) then UE1 performs reselection of SRS from SRS1 to SRS2. Otherwise, UE1 may continue using SRS1 as the synchronization source. R1≥1. In one example, R1=1.

SRS2 may operate on a third carrier frequency (F3) i.e., UE1 obtains synchronization with respect to SRS2 by receiving signals (e.g., RS) on F3. UE1 may determine SRS2 and/or F3 based on one or more rules which may be pre-defined or configured by another node or pre-configured in the UE (e.g., stored on UE1's SIM/USIM card). F3 may or may not be subject to CCA. In one example, SRS2 may have lower or equal priority compared to that of SRS1. In one example, UE1 reselects SRS2 as the new SRS provided that the signals transmitted by SRS2 on F3 are not subject to CCA e.g., F3 belongs to licensed frequency band. SRS2 may be a UE e.g., a fourth UE (UE4) or it may be a second network node (NN2). FIG. 4 illustrates scenarios in which UE1 changes/reselects its SRS from SRS1 to SRS2 due to CCA failures on F1 between UE1 and SRS1: A) UE1 changes SRS1 to SRS2 which is a second network node (NN2); B) UE1 changes SRS1 to SRS2 which is a fourth UE (UE4). FIG. 4 shows an example in which UE1 changes/reselects its SRS from SRS1 to SRS2 due to excessive number of CCA failures detected on signals transmitted by SRS1 on F1. In FIG. 4 (A), UE1 changes SRS1 to SRS2, which is a second network node (NN2). In FIG. 4 (B), UE1 changes SRS1 to SRS2 which is a fourth UE (UE4). In both cases, UE1 obtains synchronization with respect to SRS2 by receiving signals (e.g., RS) transmitted by SRS2 on F3. In one example, F3 and F2 are different carrier frequencies. In another example, F3 and F2 are the same carrier frequencies i.e., F2=F3.

### Initiating/Ceasing of Sidelink Synchronization Signals

In another example UE1 adapts the transmission of SLSS on a fourth carrier frequency (F4) based on the results of the CCA failures determined by UE1 on F1. The adaptation of the transmission of SLSS on F4 by UE1 comprising one of initiating/starting the transmission of SLSS on F4 and ceasing/stopping the transmission of SLSS on F4. F4 is a carrier frequency used or configured for the SL operation. In one example, F4 is the same as F1 or F2 or F3 or different than F1, F2 and F3.

In one example if the results of CCA procedures indicate CCA failures or high number of CCA failures on F1 for a period of time Tn (e.g., number of CCA failures is above a threshold over certain time period), then UE1 initiates SLSS transmission on F4. In one example, UE1 also starts acting as synchronization reference source (SRS) on F4 by initiating transmission of SLSS (e.g., SL-SSB, SLSS, PSBCH, etc.) based on the CCA failures on F1 in addition to the existing condition for initiating/ceasing SLSS. An example of the existing condition is when the signal measurement (signal strength e.g., RSRP etc.) on signals transmitted by SRS1 on F1 falls below certain threshold.

In one specific example, if (N>Nmax) occurs K number of times during T_{evaluate,SLSS_CCA} on F1 then UE1 starts transmitting SLSS on F4. Otherwise, it may not transmit any SLSS on F4. In the latter case UE1 is not going to act as SRS for other UEs. In another example, if UE1 is transmitting SLSS and if (N≤Nmax) on F1 at least once during T_{evaluate,SLSS_CCA} then UE1 stops/ceases transmitting SLSS on F4. K≥1. In one example, K=1.

The one or more parameters, T0, R1, K, Nmax, Tn, Z1, Z2 etc. in the above examples of the adaptations of the SRS can be pre-defined, pre-configured or configured by the network node (e.g., by transmitting a message such as via RRC to UE1). These parameters may further depend on whether UE1 is configured with normal DRX or extended DRX, frequency range (e.g., FR1, FR2), UE1's power class etc.

The type of the adaptations of the SRS applied by UE1 based on result of CCA procedure may be predefined, pre-configured (e.g., on SIM/USIM card) or configured by another node (e.g., network node or another SL UE).

Specific examples of UE1 adapting its SRS based on CCA failures

### Example 1: Selection/Reselection of SRS by UE1 Based on CCA Failures

This first example defines requirements for selection/reselection of SL (e.g., V2X) synchronization reference source (SRS) when the carrier on which the signal transmitted by the SRS (e.g., UE, network node etc) is subject to CCA.

When GNSS synchronization reference source is configured as the highest priority and
UE is synchronized to GNSS directly,
   UE shall not drop any SL (e.g., V2X) SLSS and data transmission for the purpose of selection/reselection to the synchronization reference (SyncRef) UE.
UE is synchronized to a SyncRef UE that is synchronized to GNSS directly or in-directly,
   UE shall not drop any SL (e.g., V2X) data transmission for the purpose of selection/reselection to the SyncRef UE. The UE shall be able to identify newly detectable intra-frequency SyncRef UE within T_{detect,SyncRefUE_V2X} seconds if the SyncRef UE meets the selection/reselection criterion defined in TS 38.331 v17.3.0. T_{detect,SyncRefUE_V2X} is defined as (10+L_{SL1})*X1 seconds when the carrier on which the SyncRef UE transmits signals (e.g., RS) is subject to CCA provided that: S-SSB Ês/Iot≥0 dB and the UE is allowed to drop a maximum of 30% of its SLSS transmissions during T_{detect,SyncRefUE_v2X} for the purpose of selection/reselection to the SyncRef UE. In one example, X1=0.16. In one example, L_{SL1} is the number of RS occasions (e.g., number of S-SSB occasions) of the SyncRef UE not available at the UE during the T_{detect,SyncRefUE_V2X} due to the CCA failure at the SyncRef UE.
in other case
When UE is in non-SL-DRX
   The UE shall be able to identify newly detectable intra-frequency SyncRef UE within T_{detect,SyncRefUE_V2X} seconds if the SyncRef UE meets the selection/reselection criterion defined in TS 38.331 v17.3.0. T_{detect,SyncRefUE_V2X} is defined as (50+L_{SL1})*X2 seconds when the carrier on which the SyncRef UE transmits signals (e.g., RS) is subject to CCA provided that: S-SSB Ês/Iot≥0 dB and the UE is allowed to drop a maximum of 6% of its SL (e.g., V2X) data and SLSS transmissions during T_{detect,SyncRefUE_V2X} for the purpose of selection/reselection to the SyncRef UE. In one example, X2=0.16.
   UE is allowed to drop up to 2 slots of its SL (e.g., V2X) data reception per PSBCH monitoring occasion and overall drop rate shall not exceed 0.3% of its SL (e.g., V2X) data reception during T_{detect,SyncRefUE_V2X} for the purpose of selection/reselection to the SyncRef UE.
When UE is in SL-DRX
   UE shall be able to identify newly detectable intra-frequency SyncRef UE within T_{detect,SyncRefUE_V2X} seconds if the SyncRef UE meets the selection/reselection criterion defined in TS 38.331 [2]. T_{detect,SyncRefUE_V2X} is defined as (50+L_{SL2})*X3 seconds when the carrier on which the SyncRef UE transmits signals (e.g., RS) is subject to CCA provided that: S-SSB Ês/Iot≥0 dB, the SL (e.g., V2X) UE is allowed to drop a maximum of 6% of its SL (e.g., V2X) data and SLSS transmissions for the purpose of selection/reselection to the SyncRef UE. In one example, X3=0.16. In another example, X3=max (0.16, SL-DRX length). In one example, L_{SL2} is the number of the RS occasions (e.g., S-SSB occasions) of the SyncRef UE is not available at the UE during the T_{detect,SyncRefUE_V2X} due to the CCA failure at the SyncRef UE. In another example, L_{SL2} is the number of SL-DRX cycles during which at least one RS occasion (e.g., S-SSB occasion) of the SyncRef UE is not available at the UE during the T_{detect,SyncRefUE_V2X} due to the CCA failure at the SyncRef UE.
   UE is allowed to drop up to 2 slots of its SL (e.g., V2X data reception per PSBCH monitoring occasion and UE is allowed to drop at most an aggregated window of 24 ms of its SL (e.g., V2X) data reception during T_{detect,SyncRefUE_V2X} for the purpose of selection/reselection to the SyncRef UE.
   The UE is allowed to extend T_{detect,SyncRefUE_V2X} to:
      max ((X41*X42+L_{SL3})*SL-DRX cycle length, X43 s) when the carrier on which the SyncRef UE transmits signals (e.g., RS) is subject to CCA,
   when the following conditions are satisfied over an evaluation period T_{evaluate,SLSS} which depends on if an NR cell is used as synchronization reference source, or if an EUTRA cell is used as synchronization reference source, or if an SLSS is used as synchronization reference source. If multiple SL-DRX cycles are configured, the SL-DRX cycle length is the longest one. In one example, X41=4, X42=50, X43=8 and SL-DRX cycle length is seconds. In one example, L_{SL3} is the number of SL-DRX cycles during which at least one RS occasion (e.g., S-SSB occasion) of the SyncRef UE is not available at the UE during the T_{detect,SyncRefUE_V2X} due to the CCA failure at the SyncRef UE.
      SS-RSRP is larger than syncTxThreshOoC.
         When serving cell/PCell synchronization reference source is configured as the highest priority,
When UE is in non-SL-DRX
UE shall be able to identify newly detectable intra-frequency SyncRef UE within T_{detect,SyncRefUE_V2X} seconds if the SyncRef UE meets the selection/reselection criterion defined in TS 38.331 v17.3.0. T_{detect,SyncRefUE_V2X} is defined as (50+L_{SL1})*X5 ms when the carrier on which the serving cell transmits signals (e.g., RS) is subject to CCA provided that: SCH Es/Iot≥0 dB, the SL (e.g., V2X) UE is allowed to drop a maximum of 6% of its SL (e.g., V2X data) and SLSS transmissions for the purpose of selection/reselection to the SyncRef UE. In one example, X5=160.
UE is allowed to drop up to 2 slots of its SL (e.g., V2X) data reception per PSBCH monitoring occasion and overall drop rate shall not exceed 0.3% of its SL (e.g., V2X) data reception during T_{detect,SyncRefUE_V2X} for the purpose of selection/reselection to the SyncRef UE.
When UE is in SL-DRX
   The UE shall be able to identify newly detectable intra-frequency SyncRef UE within T_{detect,SyncRefUE_V2X} seconds if the SyncRef UE meets the selection/reselection criterion defined in TS 38.331 v17.3.0. T_{detect,SyncRefUE_V2X} is defined as (50+L_{SL2})*X6 seconds when the carrier on which the serving cell transmits signals (e.g., RS) is subject to CCA provided that: SCH Es/Iot≥0 dB, the UE is allowed to drop its SL (e.g., V2X data) and SLSS transmissions at most in an aggregated window of 480 ms during T_{detect,SyncRef UE_V2X} for the purpose of selection/reselection to the SyncRef UE. In one example, X6=160.
   UE is allowed to drop up to 2 slots of its SL (e.g., V2X) data reception per PSBCH monitoring occasion and UE is allowed to drop at most an aggregated window of 24 ms of its SL (e.g., V2X) data reception during T_{detect,SyncRefUE_V2X} for the purpose of selection/reselection to the SyncRef UE.
   The UE is allowed to extend T_{detect,SyncRefUE_V2X} to:
      max((X71*X72*+L_{SL3})*SL-DRX cycle length, X73 s) when the carrier on which the serving cell transmits signals (e.g., RS) is subject to CCA,
when the following conditions are satisfied over an evaluation period T_{evaluate,SLSS} which depends on if an NR cell is used as synchronization reference source, or if an EUTRA cell is used as synchronization reference source, or if an SLSS is used as synchronization reference source. If multiple SL-DRX cycles are configured, the SL-DRX cycle length is the longest one. In one example, X71=4, X72=50, X73=8 and SL-DRX cycle length is seconds.
   SS-RSRP is larger than syncTxThreshOoC.

UE shall be capable of performing PSBCH-RSRP measurements for 3 identified intra-frequency SyncRef UE with the measurement period of T_{measure,PSBCH-RSRP} in Table 1. It is assumed that the SyncRef UE do not drop or delay any SLSS transmission within the measurement period. Otherwise, the measurement period may be extended.

TABLE 1
PSBCH-RSRP measurement period
for intra-frequency SyncRef UE

| SL-DRX cycle^{Note 1} [ms] | T_{measure, PSBCH-RSRP} [ms] |
|---|---|
| No SL-DRX | (X81 + L_{SL4})*X82 |
| SL-DRX cycle ≤ 160 ms | (X81 + L_{SL5})*X82 |
| SL-DRX cycle > 160 ms | (X81 + L_{SL5})*SL-DRX cycle |

^{Note 1}
If multiple SL-DRX cycles are configured, the SL-DRX cycle is the shortest one.
Note 2:
In one example, X81 = 2 and X82 = 160 ms.
Note 3:
In one example, L_{SL4} is the number of channel occasions (e.g., number of PSBCH) of the SyncRef UE is not available at the UE during the T_{measure, PSBCH-RSRP} due to the CCA failure at the SyncRef UE.
Note 4:
In one example, L_{SL5} is the number of SL-DRX cycles during which at least one channel occasion (e.g., PSBCH) of the SyncRef UE is not available at the UE during the T_{measure, PSBCH-RSRP} due to the CCA failure at the SyncRef UE.

When UE is synchronized to GNSS directly, before selection/reselection of the new synchronization reference source UE shall evaluate the GNSS synchronization source reliability for at least 20 seconds before changing the synchronization reference from GNSS to another synchronization reference source. UE shall be always synchronized to GNSS directly during the evaluation of GNSS synchronization source reliability.

In one example the UE stops using the current synchronization reference source if any of the following conditions is met:
L_{SL1} exceeds L_{SL,max1}
L_{SL2} exceeds L_{SL,max2}
L_{SL3} exceeds L_{SL,max3}
L_{SL4} exceeds L_{SL,max4}
L_{SL5} exceeds L_{SL,ma5}

In another example, the UE further initiates reselection of synchronization reference source procedure if any of the above conditions is met. In this procedure the UE reselects another synchronization reference source.

In another example the UE restarts the measurement on SRS (e.g., PSBCH-RSRP measurement) of the current SyncRef UE (e.g., UE3) if any of the above conditions is met.

### Example 2: Adapting of SLRS Based on CCA Failures when NR Cell is Used as Synchronization Reference Source

This second example defines requirements for the UE (e.g., UE1) initiating and ceasing SLSS transmissions when a NR cell is used as the synchronization reference source (SRS) when the carrier on which the signal transmitted by the SRS (network node) is subject to CCA.

When the NR Cell is used as synchronization reference source, the UE shall be capable of measuring the RSRP of the cell used as synchronization reference source to evaluate to initiate/cease SLSS transmissions within T_{evaluate,SLSS}
where,
T_{evaluate,SLSS,CCA} is as specified in Table 2 when UE performs SSB based measurements without measurement gaps and the measured carrier is subject to CCA.
T_{evaluate,SLSS} is as specified in Table 3 when UE performs SSB based measurements with measurement gaps and the measured carrier is subject to CCA.

TABLE 2
T_{evaluate, SLSS}_{_{—}}_{CCA} for measurements without measurement
gaps when NR cell is used as synchronization reference source (FR1)

| DRX cycle in NR cell | T_{evaluate, SLSS}_{_{—}}_{CCA} |
|---|---|
| No DRX | max(400 ms, ceil(2 × 5 × Kₚ + L_{SLSS, 1}) × |
| | SMTC period)^{Note 1} |
| DRX cycle ≤ 320 ms | max(400 ms, ceil(1.5 × 2 × 5 × Kₚ + L_{SLSS, 2}) × |
| | max(SMTC period, DRX cycle)) |
| DRX cycle > 320 ms | ceil(7 × Kₚ + L_{SLSS, 2}) × DRX cycle |

^{Note 1}
If different SMTC periodicities are configured for different cells, the SMTC period in the requirement is the one used by the cell being identified
Note 2:
L_{SLSS, 1} is the number of SMTC occasions of the NR cell not available at the UE during the evaluation period in non-DRX due to the CCA failures, where L_{SLSS, 1} < L_{SLSS, max, 1}. When DRX is configured, L_{SLSS, 2} is the number of DRX cycles in which at least one SMTC occasion of the NR cell is not available at the UE during T_{evaluate, SLSS}_{_{—}}_{CCA} due to the CCA failures; where L_{SLSS, 2} < L_{SLSS, max, 2}. When configured with DRX, the UE is not required to determine the availability of SMTC occasions more frequently than once per DRX cycle.

TABLE 3
T_{evaluate, SLSS}_{_{—}}_{CCA} for measurements with measurement gaps
when NR cell is used as synchronization reference source (FR1)

| DRX cycle in NR cell | T_{evaluate, SLSS}_{_{—}}_{CCA} |
|---|---|
| No DRX | max(400 ms, 2 × (5 + L_{SLSS, gaps, 1}) × |
| | max(MGRP, SMTC period)) × CSSFᵢₙₜᵣₐ |
| DRX cycle ≤ 320 ms | max(400 ms, ceil(2 × 1.5 × 5 + |
| | L_{SLSS, gaps, 2}) × max(MGRP, SMTC period, |
| | DRX cycle)) × CSSFᵢₙₜᵣₐ |
| DRX cycle > 320 ms | (7 + L_{SLSS, gaps, 2}) × max(MGRP, |
| | DRX cycle) × CSSFᵢₙₜᵣₐ |

Note 1:
L_{SLSS, gaps, 1} is the number of SMTC occasions of the NR cell not available at the UE during the evaluation period in non-DRX due to the CCA failures, where L_{SLSS, gaps, 1} < L_{SLSS, gaps, max, 1}. When DRX is configured, L_{SLSS, gaps, 2} is the number of DRX cycles in which at least one SMTC occasion of the NR cell is not available at the UE during T_{evaluate, SLSS}_{_{—}}_{CCA} due to the CCA failures where L_{SLSS, gaps, 2} < L_{SLSS, gaps, max, 2}. When configured with DRX, the UE is not required to determine the availability of SMTC occasions more frequently than once per DRX cycle.

The UE ceases all SLSS transmission if at least one of the following conditions is met:
L_{SLSS,1} exceeds L_{SLSS,max,1}
L_{SLSS,2} exceeds L_{SLSS,max,2}
L_{SLSS,gaps,1} exceeds L_{SLSS,gaps,max,1}
L_{SLSS,gaps,2} exceeds L_{SLSS,gaps,max,2}

Otherwise, the UE transmits SLSS based on the evaluations within T_{evaluate,SLSS}.

### Example 3: Adapting of SLRS Based on CCA Failures when EUTRAN Cell Used as Synchronization Reference Source

This third example defines requirements for initiating and ceasing SLSS transmissions when a EUTRAN cell is used as the synchronization reference source (SRS) when the carrier on which the signal transmitted by the SRS (e.g., a network node etc) is subject to CCA.

When the EUTRAN Cell is used as synchronization reference source, the UE shall be capable of measuring the RSRP of the cell used as synchronization reference source to evaluate to initiate/cease SLSS transmissions within T_{evaluate,SLSS,CCA}
where,
T_{evaluate,SLSS,CCA}=(10+L_{SLSS,3})×0.04 seconds when UE is not configured with DRX. Where, L_{SLSS,3} is the number of RS occasions (e.g., e.g., discovery signal occasions) of the E-UTRAN cell configured with 40 ms periodicity not available at the UE due to the CCA failures on F1 i.e., carrier of E-UTRAN cell.
In another example, T_{evaluate,SLSS,CCA}=(5+L_{SLSS,4})×0.08 seconds when UE is not configured with DRX. Where, L_{SLSS,4} is the number of RS occasions (e.g., e.g., discovery signal occasions) of the E-UTRAN cell configured with 80 ms periodicity not available at the UE due to the CCA failures on F1 i.e., carrier of E-UTRAN cell.
T_{evaluate,SLSS,CCA}=as specified in Table 4 when UE is configured with DRX and the measured carrier of the E-UTRAN cell is subject to CCA.

TABLE 4
T_{evaluate, SLSS, CCA} when EUTRAN cell is
used as synchronization reference source

| | T_{evaluate, SLSS, CCA} |
|---|---|
| DRX cycle length in EUTRAN cell[s] | [s] (number of DRX cycles) |
| ≤0.04 | (10 + L_{SLSS, 5}) × 0.04 (Note 1) |
| 0.04 < DRX-cycle ≤ 2.56 | Note 2 (6 + L_{SLSS, 6}) |

(Note 1)
Number of DRX cycles depends upon the DRX cycle in use
Note 2
Time depends upon the DRX cycles in use
Note 3:
L_{SLSS, 3} is the number of occasions the reference signal (e.g., discovery signals) of the E-UTRAN cell is not available at the UE during T_{evaluate, SLSS}_{_{—}}_{CCA} due to the CCA failures; where L_{SLSS, 5} ≤ L_{SLSS, max, 5}. When DRX is configured, L_{SLSS, 6} is the number of DRX cycles in which at least one occasion with reference signal (e.g., discovery signals) of the E-UTRAN cell is not available at the UE during T_{evaluate, SLSS}_{_{—}}_{CCA} due to the CCA failures; where L_{SLSS, 6} ≤ L_{SLSS, max, 6}. When configured with DRX, the UE is not required to determine the availability of the sidelink synchronization reference signal more frequent than once per DRX cycle.

The UE ceases all SLSS transmission if at least one of the following conditions is met:
L_{SLSS,3} exceeds L_{SLSS,max,3}
L_{SLSS,4} exceeds L_{SLSS,max,4}
L_{SLSS,5} exceeds L_{SLSS,max,5}
L_{SLSS,6} exceeds L_{SLSS,max,6}

Otherwise, the UE transmits SLSS based on the evaluations within T_{evaluate,SLSS}.

### Example 4: Adapting of SLRS Based on CCA Failures when SyncRef UE Used as Synchronization Reference Source

This fourth example defines requirements for initiating and ceasing SLSS transmissions when UE1 shall start transmitting SLSS when the carrier on which the signal transmitted by the SRS (e.g., UE etc.) is subject to CCA.

The UE shall be capable of measuring the PSBCH-RSRP of the selected SyncRef UE used as synchronization reference source and evaluate it to initiate/cease SLSS transmissions within T_{evaluate,SLSS}, in Table 5 when the measured carrier is subject to CCA.

TABLE 5
T_{evaluate, SLSS, CCA} when SyncRef UE is
used as synchronization reference source

| SL-DRX cycle^{Note 1} [ms] | T_{evaluate, SLSS, CCA} [ms] |
|---|---|
| No SL-DRX | (G1 + L_{SLSS, 7}) × S-SSB periods |
| SL-DRX cycle ≤ 160 ms | (G2 + L_{SLSS, 8}) × S-SSB periods |
| SL-DRX cycle > 160 ms | (G3 + L_{SLSS, 8}) × SL-DRX cycle |

^{Note 1}
If multiple SL-DRX cycles are configured for SL UE, the SL-DRX cycle in the requirement is the shortest one. When the shortest SL-DRX cycle UE used changes, the requirements do not apply to the time of transition.
Note 2:
L_{SLSS, 7} is the number of occasions containing sidelink synchronization reference signal (e.g., S-SSB) of the SyncRef UE (e.g., UE3) is not available at the UE (e.g. UE1) during T_{evaluate, SLSS}_{_{—}}_{CCA} due to the CCA failures; where L_{SLSS, 7} ≤ L_{SLSS, max, 7}. When DRX is configured, L_{SLSS, 2} is the number of DRX cycles in which at least one occasion containing the sidelink synchronization reference signal (e.g., S-SSB) of the SyncRef UE (e.g., UE3) is not available at the UE during T_{evaluate, SLSS}_{_{—}}_{CCA} due to the CCA failures; where L_{SLSS, 8} ≤ L_{SLSS, max, 8}. When configured with DRX, the UE is not required to determine the availability of the sidelink synchronization reference signal more frequent than once per DRX cycle.
Note 3:
In one example, G1 = 4, G2 = 4 and G3 = 4.

In one example, the UE (e.g., UE1) ceases all SLSS transmission if at least one of the following conditions is met:
L_{SLSS,7} exceeds L_{SLSS,max,7}
L_{SLSS,8} exceeds L_{SLSS,max,8}

Otherwise, the UE (e.g., UE1) transmits SLSS based on the evaluations within T_{evaluate,SLSS}.

In another example, the UE (e.g., UE1) suspends transmissions of SLSS during certain time period T1. In one example, T1=N×SL-DRX cycle, where N=2,3,4 etc. The UE may restart the SLSS after T or it may stop the SLSS after T.

In another example the UE restarts the measurement (e.g., evaluation of the SLSS) on SRS of the current SyncRef UE (e.g., UE3) if any of the above conditions is met.

Embodiment 2: Methods in the UE3 for operating as synchronization reference UE. The embodiments described herein can be implemented in any combination. The UE embodiment comprises at least the following: Step 1: UE3 obtains information related to need for transmitting sidelink reference signal. Step 2: UE3 determines information related to result of CCA procedure associated with SRS. Step 3: UE3 adapts transmission of a SL RS (e.g., SLSS) based on whether the associated conditions are fulfilled.

Step 1: UE3 obtaining of information related to need for transmitting sidelink reference signal. In this step, the UE3 obtains information whether it needs to transmit sidelink reference signals (SLRS), i.e., whether any other sidelink UEs (e.g., UE1) are using UE3 as the synchronization reference source. In one example, UE3 determines the need for transmitting the SLRS if UE3 is configured to transmit the SLRS by another node (e.g., by another UE (e.g., UE1) or by a network node). In another example, UE3 determines the need for transmitting the SLRS based on a pre-defined rule e.g., UE3 is required to periodically transmit SLRS. In another example, UE3 determines the need for transmitting the SLRS based on pre-configuration information in the UE (e.g., stored on UE1's SIM/USIM card). A sidelink UE acting as a SRS for other sidelink UEs is typically required to transmit sidelink reference signals (SLRS) according to a certain transmission periodicity. Examples of SLRS are SL synchronization signal (SLSS).

Step 2: UE3 determines information related to result of CCA procedure associated with SRS. In this step, the UE3 determines information related to result of CCA procedure based on one or more rules or parameters related to CCA failures associated with the sidelink reference signals transmitted by UE3 on F1.

The step of determining information related to result of CCA procedures are similar to those described in step 2 in the first embodiment discussed above.

Step 3: UE3 adapts transmission of SL reference signals based on the result of CCA procedure. In this step, the UE3 (which is acting as SRS to other SL UEs) adapts one or more procedures related to or involving the transmission of sidelink reference signals based on the result of CCA procedure determined in previous step. Examples of the different types of adaptations comprise following:

### Continue Transmission of SLRS

In one example of the adaption, UE3 continues transmitting SLRS (e.g., SLSS) on F1. For example, if the results of CCA procedures show no CCA failures on F1 or limited number of CCA failures on F1 then the UE3 may continue transmitting SLRS (e.g., SLSS) according to the reference configuration on F1. The reference configuration is the one which UE3 follows for the SLRS transmission when it does not experience any CCA failures on F1 or when number of CCA failures on F1 is below certain threshold or when operating on a carrier not subject to CCA. UE3 obtains the reference configuration for the SLRS transmission based on pre-defined information, by receiving information from another node (e.g., a UE, a network node) or based on pre-configured information (e.g., stored on UE3's SIM/USIM card etc.).

In one specific example, if (N′<Nmax′) during a certain time period (e.g., T0′) then the UE3 continues to transmit SLSS (e.g., every 160 ms) to other SL UEs (e.g., UE1) which are using UE3 as the synchronization reference source. Otherwise, UE3 does not continue transmission of the SLRS e.g., UE3 stops/ceases transmission of SLSS on F1. In another example, in the latter case, UE3 may perform any of the adaptations listed below (such as stopping/ceasing SLRS or suspending or postponing SLRS for a certain time etc.).

### Stopping/Ceasing the Transmission of SLRS for a Period of Time

In another example of the adaption, UE3 stops/ceases transmission of the SLRS (e.g., SLSS) on F1 for certain time period. The stopping/ceasing the transmission of the SLRS implied not transmitting the SLRS. For example if the results of CCA procedures show CCA failures or high number of CCA failures (e.g., number of CCA failures is above a threshold), then UE3 may stop/cease transmission of SLRS (e.g., SLSS) for a period of time Tn′. The reasons for stopping/ceasing the transmission are twofold. Firstly, it will be unnecessary complexity in UE3 and wastage of resources to attempt SLRS transmission if UE3 has detected that the channel has been quite busy over last Nx time period, where Nx can be expressed in a time unit e.g., subframes, DRX cycles, slots etc. Secondly, any such transmission may also cause interference to other nearby devices. Therefore, UE3 prefers to cease all SLRS transmission for a period of time.

In one specific example, if (N′>Nmax′) occurs K′ number of times then UE3 stops/ceases transmission of SLRS (e.g., SLSS). Otherwise, it may continue to transmit SLRS (e.g., SLSS) following the reference configuration. K′≥1. In one example, K′=1.

In another specific example, if (N′>Nmax′) occurs R1′ number of times during a certain time period (e.g., T0′) then the UE3 stops/ceases transmissions of SLRS (e.g., SLSS) to UE1 which is using UE3 as the synchronization reference source. Otherwise, the UE may continue to transmit SLRS (e.g., SLSS) following the reference configuration. R1′≥1. In one example, R1′=1.

### Suspending or Postponing Transmission of SLRS for a Period of Time

In another example of the adaption, UE3 suspends or postpones the transmission of the SLRS (e.g., SLSS) on F1 for certain time period. For example, if the results of CCA procedures indicate CCA failures or high number of CCA failures (e.g., number of CCA failures is above a threshold), then UE3 suspends or postpones transmission of SLRS for a period of time Tn′. The rationale for suspending or postponing the SLRS transmission is to avoid any transmission while the channel is occupied by other nodes (e.g., other UEs, network node etc.) and to reattempt transmission after some time. The period of time when the transmissions are suspended or postponed by UE3 may further depend on type of channel access scheme applied.

In one specific example, if (N′>Nmax′) occurs K′ number of times then UE3 suspends or postpones transmission of SLRS (e.g., SLSS). Otherwise, it may continue to transmit SLRS (e.g., SLSS) following the reference configuration. K′>1. In one example, K′=1.

In another specific example, if (N′>Nmax′) occurs R1′ number of times during a certain time period (e.g., T0′) then UE3 suspends or postpones transmissions of SLRS (e.g., SLSS) to UE1 which is using UE3 as the synchronization reference source. Otherwise, the UE may continue to transmit SLRS (e.g., SLSS) following the reference configuration. R1′≥1. In one example, R1′=1.

### Adapting of SLRS

If the results of CCA procedures indicate CCA failures or high number of CCA failures (e.g., number of CCA failures is above a threshold), then UE3 adapts one or more transmission parameters of SLRS. Examples of the transmission parameters of SLRS are periodicity of SLRS transmission, duration (e.g., X1 ms, X2 symbols, X3 slots etc.) of the occasion over which the SLRS is transmitted, bandwidth over which SLRS is transmitted, etc. In one example, adaptation comprises UE3 transmitting SLRS less frequently compared to a reference periodicity (e.g., when not experiencing any CCA failures). In another example, adaptation comprises UE3 transmitting SLRS more frequently compared to the reference periodicity.). In another example, adaptation comprises UE3 transmitting SLRS over a bandwidth (BW) smaller than a reference BW. In another example, adaptation comprises UE3 transmitting SLRS over a bandwidth larger than a reference BW. The reference SLRS periodicity and/or reference BW can be pre-defined, configured by another node or pre-configured in UE3.

The one or more parameters, T0′, R1′, K′, Nmax′, Tn′, Z1′, In the above examples of the adaptation can be pre-defined, pre-configured or configured by the network node (e.g., by transmitting a message such as via RRC to UE3). These parameters may further depend on whether UE3 is configured with normal DRX or extended DRX, frequency range (e.g., FR1, FR2), UE3's power class etc.

The type of the adaptations of the SLRS applied by UE3 based on result of CCA procedure may be predefined, pre-configured (e.g., on SIM/USIM card) or configured by another node (e.g., network node or another SL UE).

The sidelink UE (e.g., UE3) is required to evaluate whether to initiate/cease SLRS (e.g., SLSS) over a fixed period of time (T_{evaluate,SLSS}). In one example, the UE (e.g., UE3) which is synchronized to any other synchronization reference sources (such as NR cell, E-UTRAN cell, GNSS, another sidelink synchronization reference UE) initiates the transmission of SLRS if it has detected certain number of CCA failures (e.g., N) over a period of time Tn′ even before completing an evaluation period (T_{evaluate,SLSS}). In another example, the UE (e.g., UE3) restarts the evaluation if it has detected certain number of CCA failures (e.g., N′>Nmax′) during an ongoing evaluation period. In yet another example, the SL UE (e.g., UE3) upon having restarted the evaluation a certain number of times, suspends any SLRS transmission for a certain period of time.

### Specific Example of UE3 Adapting the SLRS Based on CCA Failures

### Example: SyncRef UE Used as Synchronization Reference Source

This example defines requirements for ceasing SLSS transmissions when SyncRef UE (UE3) is used as the synchronization reference source (SRS) for UE1 when the carrier on which the signal transmitted by the SRS (e.g., UE3 etc) is subject to CCA.

The UE (e.g., UE1) shall be capable of measuring the PSBCH-RSRP of the selected SyncRef UE (e.g., UE3) used as synchronization reference source and evaluate it to initiate/cease SLSS transmissions within T_{evaluate,SLSS}, in Table 6 when the measured carrier (e.g., F1) is subject to CCA.

TABLE 6
T_{evaluate, SLSS, CCA} when SyncRef UE is
used as synchronization reference source

| SL-DRX cycle^{Note 1} [ms] | T_{evaluate, SLSS, CCA} [ms] |
|---|---|
| No SL-DRX | (H1 + L_{SLSS, 9}) × S-SSB periods |
| SL-DRX cycle ≤ 160 ms | (H2 + L_{SLSS, 10}) × S-SSB periods |
| SL-DRX cycle > 160 ms | (H3 + L_{SLSS, 10}) × SL-DRX cycle |

^{Note 1}
If multiple SL-DRX cycles are configured for SL UE, the SL-DRX cycle in the requirement is the shortest one. When the shortest SL-DRX cycle UE used changes, the requirements do not apply to the time of transition.
Note 2:
L_{SLSS, 9} is the number of occasions containing sidelink synchronization reference signal (e.g., S-SSB) of the SyncRef UE (e.g., UE3) is not available at the UE (e.g. UE1) during T_{evaluate, SLSS}_{_{—}}_{CCA} due to the CCA failures; where L_{SLSS, 9} ≤ L_{SLSS, max, 9}. When DRX is configured, L_{SLSS, 2} is the number of DRX cycles in which at least one occasion containing the sidelink synchronization reference signal (e.g., S-SSB) of the SyncRef UE (e.g., UE3) is not available at the UE during T_{evaluate, SLSS}_{_{—}}_{CCA} due to the CCA failures; where L_{SLSS, 10} ≤ L_{SLSS, max, 10}. When configured with DRX, the UE is not required to determine the availability of the sidelink synchronization reference signal (e.g., S-SSB) of the SyncRef UE (e.g., UE3) more frequent than once per DRX cycle.
Note 3:
In one example, H1 = 4, H2 = 4 and H3 = 4.

In one example, the SyncRef UE (e.g., UE3) ceases all SLSS transmission if at least one of the following conditions is met:
L_{SLSS,9} exceeds L_{SLSS,max,9}
L_{SLSS,10} exceeds L_{SLSS,max,10}

Otherwise, the UE (e.g., UE1) transmits SLSS based on the evaluations within Tevaluate,SLSS.

In another example, the UE (e.g., UE1) suspends transmissions of SLSS during certain time period T1. In one example, T1=N×SL-DRX cycle, where N=2,3,4 etc. The UE may restart the SLSS after T or it may stop the SLSS after T.

TABLE
T_{detect, NR}_{_{—}}_{Intra}_{_{—}}_{CCA}, T_{measure, NR}_{_{—}}_{Intra}_{_{—}}_{CCA} and T_{evaluate, NR}_{_{—}}_{Intra}_{_{—}}_{CCA}

| DRX | | | | | |
|---|---|---|---|---|---|
| cycle | Scaling | | T_{detect, NR}_{_{—}}_{Intra}_{_{—}}_{CCA} [s] | T_{measure, NR}_{_{—}}_{Intra}_{_{—}}_{CCA} | T_{evaluate, NR}_{_{—}}_{Intra}_{_{—}}_{CCA} |
| length | Factor (N1) | | (number of DRX | [s] (number of DRX | [s] (number of |
| [s] | FR1 | FR2-2 ^{Note 5} | cycles) | cycles) | DRX cycles) |
| 0.32 | 1 | 12 | 0.32 × N1 × (36 + M_{d}) × M2 | 0.32 × N1 × (4 + Mₘ) × M2 | 0.32 × N1 × |
| | | | {(36 + M_{d}) × N1 × M2} | {(4 + Mₘ) × N1 × M2 | (16 + Mₑ) × M2 |
| | | | | | {(16 + Mₑ) × N1 × M2} |
| 0.64 | | 8 | 0.64 × N1 × (28 + M_{d}) | 0.64 × N1 × (2 + Mₘ) | 0.64 × N1 × (8 + Mₑ) |
| | | | {(28 + M_{d}) × N1} | {(2 + Mₘ) × N1} | {(8 + Mₑ) × N1} |
| 1.28 | | 6 | 1.28 × N1 × (25 + M_{d}) | 1.28 × N1 × (1 + Mₘ) | 1.28 × N1 × (5 + Mₑ) |
| | | | {(25 + M_{d}) × N1} | {(1 + Mₘ) × N1} | {(5 + Mₑ) × N1} |
| 2.56 | | 5 | 2.56 × N1 × (23 + M_{d}) | 2.56 × N1 × (1 + Mₘ) | 2.56 × N1 × (3 + Mₑ) |
| | | | {(23 + M_{d}) × N1} | {(1 + Mₘ) × N1} | {(3 + Mₑ) × N1} |

Note 1:
M2 = 1.5 if SMTC periodicity of measured intra-frequency cell > 20 ms; otherwise M2 = 1.
Note 2:
Md, Mm, Me are the number of groups of consecutive N1 DRX cycles each group with at least one SMTC occasion not available during the T_{detect, NR}_{_{—}}_{Intra}_{_{—}}_{CCA}, T_{measure, NR}_{_{—}}_{Intra}_{_{—}}_{CCA} and T_{evaluate, NR}_{_{—}}_{Intra}_{_{—}}_{CCA}, and Mₘ ≤ M_{m, max}, M_{d} ≤ M_{d, max} and Mₑ ≤ M_{e, max}
Note 3:
M_{m, max} = 16 for DRX cycle length = 0.32 s; M_{m, max} = 8 for DRX cycle length = 0.64 s; M_{m, max} = 4 for DRX cycle length = 1.28 s; M_{m, max} = 4 for DRX cycle length = 2.56 s.
Note 4:
M_{d, max} = 4*M_{m, max}, M_{e, max} = 2*M_{m, max}.
^{Note 5}
Applies for UE supporting FR2-2 power class 2&3. For UE supporting FR2-2 power class 1, N1 = 12 for all DRX cycle length.

In some embodiments, the UE shall restart the measurements upon exceeding M_{m,max}, M_{d,max}, or M_{e,max}.

The current RRM specification (see, e.g., TS 38.133, section 12.4) contains requirements for selection and reselection of synchronization reference sources. More specifically, it contains requirements for detecting a new synchronization reference sources (SyncRefUEs) when UE is synchronized to GNSS, SyncRefUE or serving cell/PCell. Examples of such requirements are time to detect newly detectable SyncRefUE, measurement period for measurements of identified SyncRefUEs, interruption time and dropping rate etc. These requirements further depend on the activity state of the UE, i.e., whether the UE is in DRX or non-DRX mode.

In the Rel-18 scenario, the SL carrier can be subject to CCA and the WAN/Uu carrier is not subject to CCA. Therefore, the selection/reselection of the SyncRefUE on the SL carrier subject to CCA will be impacted due to the CCA failures on the SL carrier. The UE will not be able to meet the existing requirements for the selection/reselection of the SyncRefUE when operating on a carrier subject to CCA and experiencing many CCA failures. For example, the UE selecting or reselecting SyncRefUE as a synchronization reference source on a carrier subject to CCA may result in UE selecting/reselecting less reliable or incorrect SyncRefUE under large number of the CCA failures. Therefore, the principle for defining the requirements for selecting/reselecting synchronization reference sources (SyncRefUE) when operating on unlicensed carrier subject to CCA failures can be based on Rel-16 NR-U requirements.

Observation 1: Excessive number of CCA failures on a SL carrier subject to CCA may result in unreliable or incorrect selection/reselection of synchronization reference sources (SyncRefUE) on that SL carrier.

Observation 2: Rel-16 NR-U requirements and the UE measurement behaviour take into account the number of CCA failures on a carrier subject to CCA.

Proposal 1: The requirements for selection and reselection of synchronization reference sources (SyncRefUE) on a SL carrier subject to CCA shall take into account the impact of the CCA failures occurring on the SL carrier during the selection and reselection of the SyncRefUE.

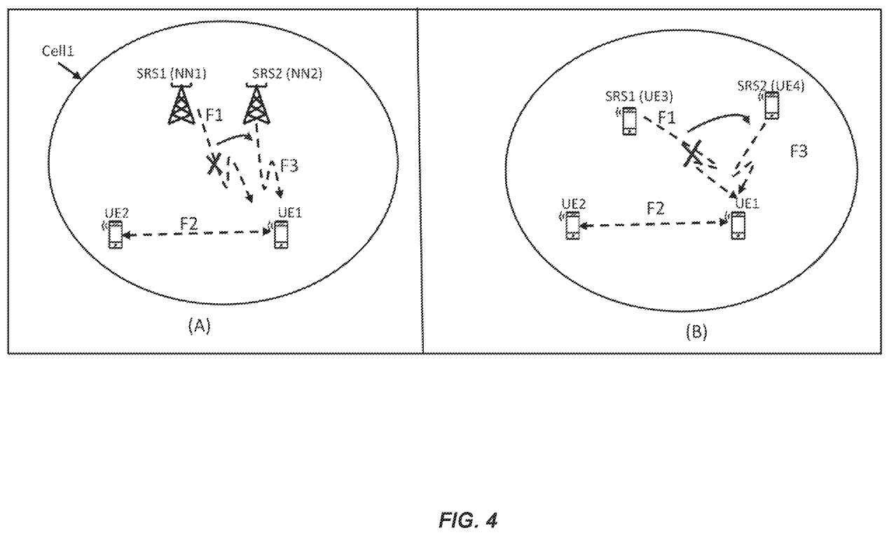

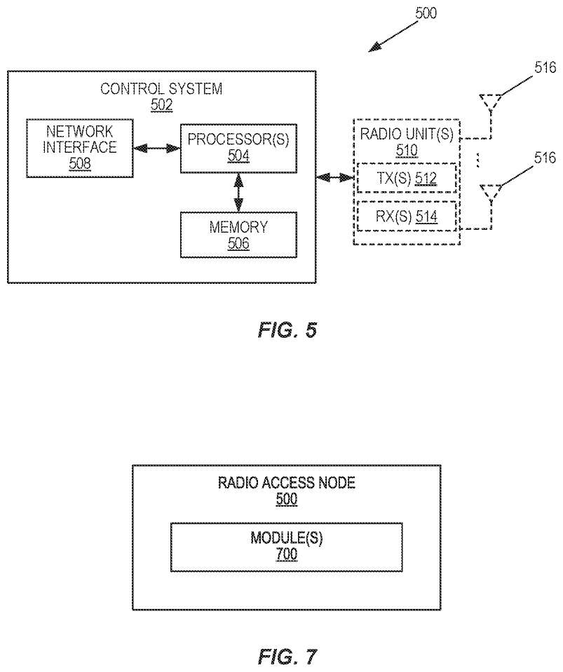

FIG. 5 is a schematic block diagram of a radio access node 500 according to some embodiments of the present disclosure. Optional features are represented by dashed boxes. The radio access node 500 may be, for example, a base station 202 or 206 or a network node that implements all or part of the functionality of the base station 202 or gNB described herein. As illustrated, the radio access node 500 includes a control system 502 that includes one or more processors 504 (e.g., Central Processing Units (CPUs), Application Specific Integrated Circuits (ASICs), Field Programmable Gate Arrays (FPGAs), and/or the like), memory 506, and a network interface 508. The one or more processors 504 are also referred to herein as processing circuitry. In addition, the radio access node 500 may include one or more radio units 510 that each includes one or more transmitters 512 and one or more receivers 514 coupled to one or more antennas 516. The radio units 510 may be referred to or be part of radio interface circuitry. In some embodiments, the radio unit(s) 510 is external to the control system 502 and connected to the control system 502 via, e.g., a wired connection (e.g., an optical cable). However, in some other embodiments, the radio unit(s) 510 and potentially the antenna(s) 516 are integrated together with the control system 502. The one or more processors 504 operate to provide one or more functions of a radio access node 500 as described herein. In some embodiments, the function(s) are implemented in software that is stored, e.g., in the memory 506 and executed by the one or more processors 504.

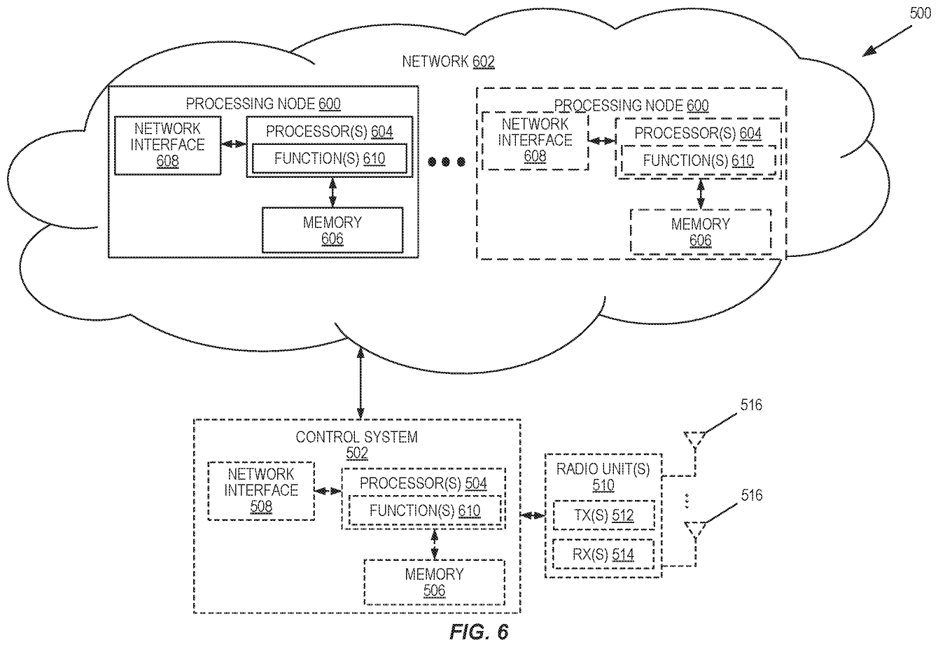

FIG. 6 is a schematic block diagram that illustrates a virtualized embodiment of the radio access node 500 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 500 in which at least a portion of the functionality of the radio access node 500 is implemented as a virtual component(s) (e.g., via a virtual machine(s) executing on a physical processing node(s) in a network(s)). As illustrated, in this example, the radio access node 500 may include the control system 502 and/or the one or more radio units 510, as described above.

The control system 502 may be connected to the radio unit(s) 510 via, for example, an optical cable or the like. The radio access node 500 includes one or more processing nodes 600 coupled to or included as part of a network(s) 602. If present, the control system 502 or the radio unit(s) are connected to the processing node(s) 600 via the network 602. Each processing node 600 includes one or more processors 604 (e.g., CPUs, ASICs, FPGAs, and/or the like), memory 606, and a network interface 608.

In this example, functions 610 of the radio access node 500 described herein are implemented at the one or more processing nodes 600 or distributed across the one or more processing nodes 600 and the control system 502 and/or the radio unit(s) 510 in any desired manner. In some particular embodiments, some or all of the functions 610 of the radio access node 500 described herein are implemented as virtual components executed by one or more virtual machines implemented in a virtual environment(s) hosted by the processing node(s) 600. As will be appreciated by one of ordinary skill in the art, additional signaling or communication between the processing node(s) 600 and the control system 502 is used in order to carry out at least some of the desired functions 610. Notably, in some embodiments, the control system 502 may not be included, in which case the radio unit(s) 510 communicate directly with the processing node(s) 600 via an appropriate network interface(s).

In some embodiments, a computer program including instructions which, when executed by at least one processor, causes the at least one processor to carry out the functionality of radio access node 500 or a node (e.g., a processing node 600) implementing one or more of the functions 610 of the radio access node 500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the radio access node 500 according to some other embodiments of the present disclosure. The radio access node 500 includes one or more modules 700, each of which is implemented in software. The module(s) 700 provide the functionality of the radio access node 500 described herein. This discussion is equally applicable to the processing node 600 of FIG. 6 where the modules 700 may be implemented at one of the processing nodes 600 or distributed across multiple processing nodes 600 and/or distributed across the processing node(s) 600 and the control system 502.

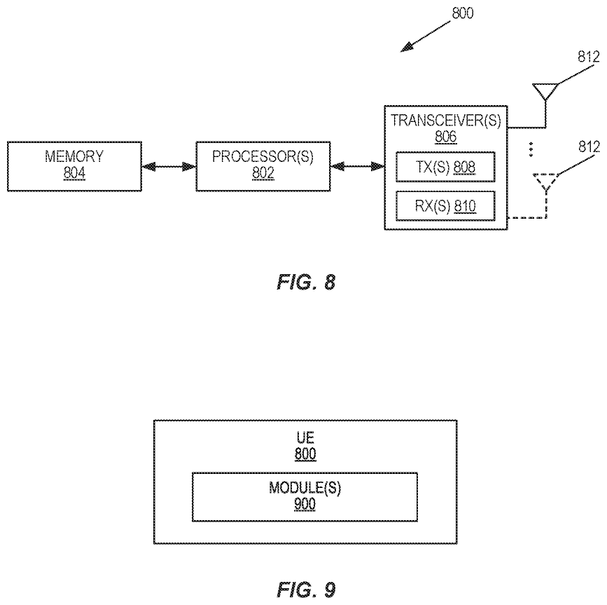

FIG. 8 is a schematic block diagram of a wireless communication device 800 according to some embodiments of the present disclosure. As illustrated, the wireless communication device 800 includes one or more processors 802 (e.g., CPUs, ASICs, FPGAs, and/or the like), memory 804, and one or more transceivers 806 each including one or more transmitters 808 and one or more receivers 810 coupled to one or more antennas 812. The transceiver(s) 806 includes radio-front end circuitry connected to the antenna(s) 812 that is configured to condition signals communicated between the antenna(s) 812 and the processor(s) 802, as will be appreciated by one of ordinary skill in the art. The processors 802 are also referred to herein as processing circuitry. The transceivers 806 are also referred to herein as radio circuitry. In some embodiments, the functionality of the wireless communication device 800 described above may be fully or partially implemented in software that is, e.g., stored in the memory 804 and executed by the processor(s) 802. Note that the wireless communication device 800 may include additional components not illustrated in FIG. 8 such as, e.g., one or more user interface components (e.g., an input/output interface including a display, buttons, a touch screen, a microphone, a speaker(s), and/or the like and/or any other components for allowing input of information into the wireless communication device 800 and/or allowing output of information from the wireless communication device 800), a power supply (e.g., a battery and associated power circuitry), etc.

In some embodiments, a computer program including instructions which, when executed by at least one processor, causes the at least one processor to carry out the functionality of the wireless communication device 800 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 9 is a schematic block diagram of the wireless communication device 800 according to some other embodiments of the present disclosure. The wireless communication device 800 includes one or more modules 900, each of which is implemented in software. The module(s) 900 provide the functionality of the wireless communication device 800 described herein.

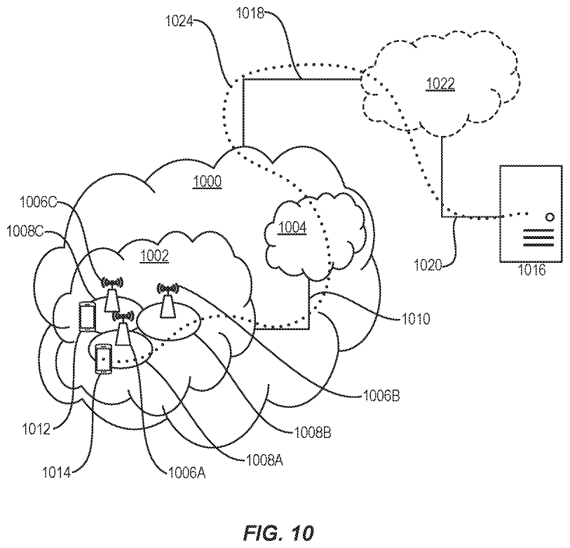

With reference to FIG. 10, in accordance with an embodiment, a communication system includes a telecommunication network 1000, such as a 3GPP-type cellular network, which comprises an access network 1002, such as a RAN, and a core network 1004. The access network 1002 comprises a plurality of base stations 1006A, 1006B, 1006C, such as Node Bs, eNBs, gNBs, or other types of wireless Access Points (APs), each defining a corresponding coverage area 1008A, 1008B, 1008C. Each base station 1006A, 1006B, 1006C is connectable to the core network 1004 over a wired or wireless connection 1010. A first UE 1012 located in coverage area 1008C is configured to wirelessly connect to, or be paged by, the corresponding base station 1006C. A second UE 1014 in coverage area 1008A is wirelessly connectable to the corresponding base station 1006A. While a plurality of UEs 1012, 1014 are illustrated in this example, the disclosed embodiments are equally applicable to a situation where a sole UE is in the coverage area or where a sole UE is connecting to the corresponding base station 1006.

The telecommunication network 1000 is itself connected to a host computer 1016, which may be embodied in the hardware and/or software of a standalone server, a cloud-implemented server, a distributed server, or as processing resources in a server farm. The host computer 1016 may be under the ownership or control of a service provider or may be operated by the service provider or on behalf of the service provider. Connections 1018 and 1020 between the telecommunication network 1000 and the host computer 1016 may extend directly from the core network 1004 to the host computer 1016 or may go via an optional intermediate network 1022. The intermediate network 1022 may be one of, or a combination of more than one of, a public, private, or hosted network; the intermediate network 1022, if any, may be a backbone network or the Internet; in particular, the intermediate network 1022 may comprise two or more sub-networks (not shown).

The communication system of FIG. 10 as a whole enables connectivity between the connected UEs 1012, 1014 and the host computer 1016. The connectivity may be described as an Over-the-Top (OTT) connection 1024. The host computer 1016 and the connected UEs 1012, 1014 are configured to communicate data and/or signaling via the OTT connection 1024, using the access network 1002, the core network 1004, any intermediate network 1022, and possible further infrastructure (not shown) as intermediaries. The OTT connection 1024 may be transparent in the sense that the participating communication devices through which the OTT connection 1024 passes are unaware of routing of uplink and downlink communications. For example, the base station 1006 may not or need not be informed about the past routing of an incoming downlink communication with data originating from the host computer 1016 to be forwarded (e.g., handed over) to a connected UE 1012. Similarly, the base station 1006 need not be aware of the future routing of an outgoing uplink communication originating from the UE 1012 towards the host computer 1016.

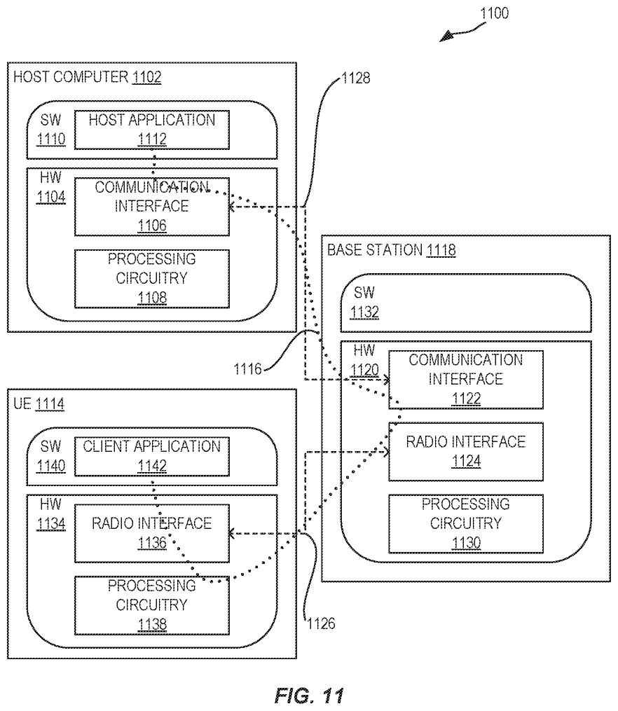

Example implementations, in accordance with an embodiment, of the UE, base station, and host computer discussed in the preceding paragraphs will now be described with reference to FIG. 11. In a communication system 1100, a host computer 1102 comprises hardware 1104 including a communication interface 1106 configured to set up and maintain a wired or wireless connection with an interface of a different communication device of the communication system 1100. The host computer 1102 further comprises processing circuitry 1108, which may have storage and/or processing capabilities. In particular, the processing circuitry 1108 may comprise one or more programmable processors, ASICs, FPGAs, or combinations of these (not shown) adapted to execute instructions. The host computer 1102 further comprises software 1110, which is stored in or accessible by the host computer 1102 and executable by the processing circuitry 1108. The software 1110 includes a host application 1112. The host application 1112 may be operable to provide a service to a remote user, such as a UE 1114 connecting via an OTT connection 1116 terminating at the UE 1114 and the host computer 1102. In providing the service to the remote user, the host application 1112 may provide user data which is transmitted using the OTT connection 1116.

The communication system 1100 further includes a base station 1118 provided in a telecommunication system and comprising hardware 1120 enabling it to communicate with the host computer 1102 and with the UE 1114. The hardware 1120 may include a communication interface 1122 for setting up and maintaining a wired or wireless connection with an interface of a different communication device of the communication system 1100, as well as a radio interface 1124 for setting up and maintaining at least a wireless connection 1126 with the UE 1114 located in a coverage area (not shown in FIG. 11) served by the base station 1118. The communication interface 1122 may be configured to facilitate a connection 1128 to the host computer 1102. The connection 1128 may be direct or it may pass through a core network (not shown in FIG. 11) of the telecommunication system and/or through one or more intermediate networks outside the telecommunication system. In the embodiment shown, the hardware 1120 of the base station 1118 further includes processing circuitry 1130, which may comprise one or more programmable processors, ASICs, FPGAs, or combinations of these (not shown) adapted to execute instructions. The base station 1118 further has software 1132 stored internally or accessible via an external connection.

The communication system 1100 further includes the UE 1114 already referred to. The UE's 1114 hardware 1134 may include a radio interface 1136 configured to set up and maintain a wireless connection 1126 with a base station serving a coverage area in which the UE 1114 is currently located. The hardware 1134 of the UE 1114 further includes processing circuitry 1138, which may comprise one or more programmable processors, ASICs, FPGAs, or combinations of these (not shown) adapted to execute instructions. The UE 1114 further comprises software 1140, which is stored in or accessible by the UE 1114 and executable by the processing circuitry 1138. The software 1140 includes a client application 1142. The client application 1142 may be operable to provide a service to a human or non-human user via the UE 1114, with the support of the host computer 1102. In the host computer 1102, the executing host application 1112 may communicate with the executing client application 1142 via the OTT connection 1116 terminating at the UE 1114 and the host computer 1102. In providing the service to the user, the client application 1142 may receive request data from the host application 1112 and provide user data in response to the request data. The OTT connection 1116 may transfer both the request data and the user data. The client application 1142 may interact with the user to generate the user data that it provides.

It is noted that the host computer 1102, the base station 1118, and the UE 1114 illustrated in FIG. 11 may be similar or identical to the host computer 1016, one of the base stations 1006A, 1006B, 1006C, and one of the UEs 1012, 1014 of FIG. 10, respectively. This is to say, the inner workings of these entities may be as shown in FIG. 11 and independently, the surrounding network topology may be that of FIG. 10.

In FIG. 11, the OTT connection 1116 has been drawn abstractly to illustrate the communication between the host computer 1102 and the UE 1114 via the base station 1118 without explicit reference to any intermediary devices and the precise routing of messages via these devices. The network infrastructure may determine the routing, which may be configured to hide from the UE 1114 or from the service provider operating the host computer 1102, or both. While the OTT connection 1116 is active, the network infrastructure may further take decisions by which it dynamically changes the routing (e.g., on the basis of load balancing consideration or reconfiguration of the network).

The wireless connection 1126 between the UE 1114 and the base station 1118 is in accordance with the teachings of the embodiments described throughout this disclosure. One or more of the various embodiments improve the performance of OTT services provided to the UE 1114 using the OTT connection 1116, in which the wireless connection 1126 forms the last segment. More precisely, the teachings of these embodiments may improve the e.g., data rate, latency, power consumption, etc. and thereby provide benefits such as e.g., reduced user waiting time, relaxed restriction on file size, better responsiveness, extended battery lifetime.

A measurement procedure may be provided for the purpose of monitoring data rate, latency, and other factors on which the one or more embodiments improve. There may further be an optional network functionality for reconfiguring the OTT connection 1116 between the host computer 1102 and the UE 1114, in response to variations in the measurement results. The measurement procedure and/or the network functionality for reconfiguring the OTT connection 1116 may be implemented in the software 1110 and the hardware 1104 of the host computer 1102 or in the software 1140 and the hardware 1134 of the UE 1114, or both. In some embodiments, sensors (not shown) may be deployed in or in association with communication devices through which the OTT connection 1116 passes; the sensors may participate in the measurement procedure by supplying values of the monitored quantities exemplified above or supplying values of other physical quantities from which the software 1110, 1140 may compute or estimate the monitored quantities. The reconfiguring of the OTT connection 1116 may include message format, retransmission settings, preferred routing, etc.; the reconfiguring need not affect the base station 1118, and it may be unknown or imperceptible to the base station 1118. Such procedures and functionalities may be known and practiced in the art. In certain embodiments, measurements may involve proprietary UE signaling facilitating the host computer's 1102 measurements of throughput, propagation times, latency, and the like. The measurements may be implemented in that the software 1110 and 1140 causes messages to be transmitted, in particular empty or ‘dummy’ messages, using the OTT connection 1116 while it monitors propagation times, errors, etc.

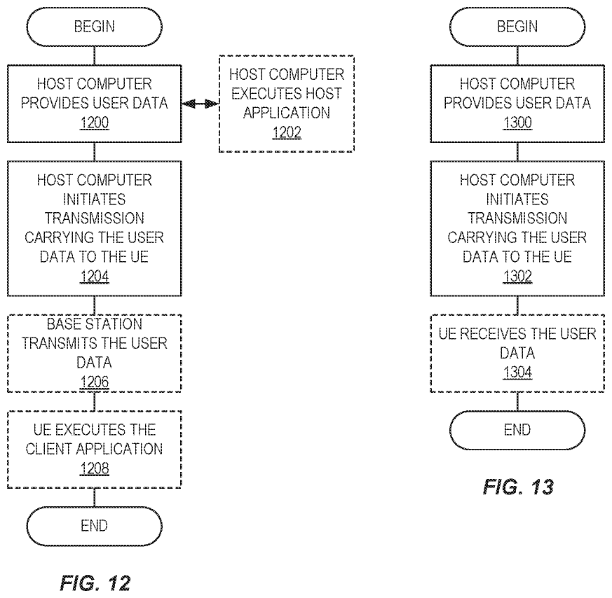

FIG. 12 is a flowchart illustrating a method implemented in a communication system, in accordance with one embodiment. The communication system includes a host computer, a base station, and a UE which may be those described with reference to FIGS. 10 and 11. For simplicity of the present disclosure, only drawing references to FIG. 12 will be included in this section. In step 1200, the host computer provides user data. In sub-step 1202 (which may be optional) of step 1200, the host computer provides the user data by executing a host application. In step 1204, the host computer initiates a transmission carrying the user data to the UE. In step 1206 (which may be optional), the base station transmits to the UE the user data which was carried in the transmission that the host computer initiated, in accordance with the teachings of the embodiments described throughout this disclosure. In step 1208 (which may also be optional), the UE executes a client application associated with the host application executed by the host computer.

FIG. 13 is a flowchart illustrating a method implemented in a communication system, in accordance with one embodiment. The communication system includes a host computer, a base station, and a UE which may be those described with reference to FIGS. 10 and 11. For simplicity of the present disclosure, only drawing references to FIG. 13 will be included in this section. In step 1300 of the method, the host computer provides user data. In an optional sub-step (not shown) the host computer provides the user data by executing a host application. In step 1302, the host computer initiates a transmission carrying the user data to the UE. The transmission may pass via the base station, in accordance with the teachings of the embodiments described throughout this disclosure. In step 1304 (which may be optional), the UE receives the user data carried in the transmission.

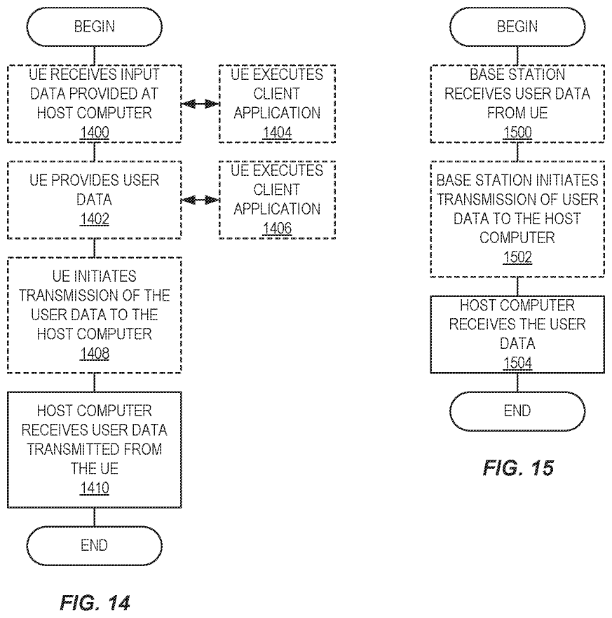

FIG. 14 is a flowchart illustrating a method implemented in a communication system, in accordance with one embodiment. The communication system includes a host computer, a base station, and a UE which may be those described with reference to FIGS. 10 and 11. For simplicity of the present disclosure, only drawing references to FIG. 14 will be included in this section. In step 1400 (which may be optional), the UE receives input data provided by the host computer. Additionally or alternatively, in step 1402, the UE provides user data. In sub-step 1404 (which may be optional) of step 1400, the UE provides the user data by executing a client application. In sub-step 1406 (which may be optional) of step 1402, the UE executes a client application which provides the user data in reaction to the received input data provided by the host computer. In providing the user data, the executed client application may further consider user input received from the user. Regardless of the specific manner in which the user data was provided, the UE initiates, in sub-step 1408 (which may be optional), transmission of the user data to the host computer. In step 1410 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station, and a UE which may be those described with reference to FIGS. 10 and 11. For simplicity of the present disclosure, only drawing references to FIG. 15 will be included in this section. In step 1500 (which may be optional), in accordance with the teachings of the embodiments described throughout this disclosure, the base station receives user data from the UE. In step 1502 (which may be optional), the base station initiates transmission of the received user data to the host computer. In step 1504 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### EMBODIMENTS

### Group a Embodiments

Embodiment 1: A method performed by a User Equipment, UE, for selecting and/or maintaining a synchronization source, the method comprising one or more of: obtaining information about the configured synchronization source and/or the available synchronization sources; determining whether there is a need for adapting Synchronization Reference Source, SRS, based on the at least CCA procedure; and performing the adaptation of SRS, which meets the criteria.

Embodiment 2: The method of the previous embodiment wherein obtaining information comprises obtaining information about the SRS based on a message received from the network node (e.g., configuration via signaling such as via RRC, DCI or MAC-CE).

Embodiment 3: The method of any of the previous embodiments wherein a set of SRSs may be pre-defined and UE selects one SR, a first SRS (SRS1) from the set of predefined SRSs based on the received identifiers from the network node.

Embodiment 4: The method of any of the previous embodiments wherein if the UE is configured with a first identifier assuming gNB/eNB based synchronization configuration, then the UE selects or uses gNB/eNB as synchronization reference source.

Embodiment 5: The method of any of the previous embodiments wherein if the UE is configured with the second identifier then the UE uses GNSS as the synchronization reference source.

Embodiment 6: The method of any of the previous embodiments wherein the set of SRSs are pre-defined and the UE selects one SRS from the set of SRSs based on one or more rules.

Embodiment 7: The method of any of the previous embodiments wherein the rules are associated with UE's operating scenarios (e.g., in-coverage, out-of-coverage, or partial coverage).

Embodiment 8: The method of any of the previous embodiments wherein determining whether there is a need for adapting SRS based on the at least CCA procedure comprises: determining information related to result of CCA procedure based on one or more rules or parameters related to CCA failures associated with the signals transmitted by the first SRS (SRS1).

Embodiment 9: The method of any of the previous embodiments wherein the rules are: pre-defined, preconfigured (e.g., on SIM/USIM card), and/or configured by a node (e.g., by another UE, a network node).

Embodiment 10: The method of any of the previous embodiments wherein performing the adaptation of SRS, which meets the criteria comprises: adapting one or more procedures related to or involving the SRS based on the result of CCA procedure as determined.

Embodiment 11: The method of any of the previous embodiments wherein adaptations performed by UE with respect to the SRS based on the results of the CCA comprise one or more of: a. continuing using SRS1 as the synchronization reference source; b. discarding, suspending, and/or postponing using SRS1 as the synchronization reference source for a certain time period of time; c. After suspending or postponing use of SRS1 as the synchronization sources for a time period, UE may resume using SRS1 as the synchronization source when one or more conditions are met, (e.g., when N1 number of CCA evaluations has succeeded); d. resume using SRS1 as the synchronization source when it has performed a reselection to a new cell; e. reselect (i.e., starts using a new synchronization reference source) another synchronization source (e.g. SRS2); f. adapts the transmission of SLSS on a fourth carrier frequency (F4) based on the results of the CCA failures determined by UE on F1; and g. if the results of CCA procedures indicate CCA failures or high number of CCA failures on F1 for a period of time Tn (e.g., number of CCA failures is above a threshold over certain time period), then UE1 initiates SLSS transmission on F4.

Embodiment 12: A method performed by a User Equipment, UE, for operating as a synchronization reference UE, the method comprising one or more of: obtaining information related to need for transmitting sidelink reference signal; determining information related to result of CCA procedure associated with SRS; and performing the adaptation transmission of a SL RS (e.g., SLSS) based on whether the associated conditions are fulfilled.

Embodiment 13: The method of any of the previous embodiments wherein obtaining information comprises one or more of: a. obtaining information whether it needs to transmit sidelink reference signals (SLRS), i.e., whether any other sidelink UEs (e.g., UE1) are using UE3 as the synchronization reference source; b. determining the need for transmitting the SLRS if UE is configured to transmit the SLRS by another node (e.g., by another UE (e.g., UE1) or by a network node); c. determining the need for transmitting the SLRS if UE is configured to transmit the SLRS by another node (e.g., by another UE (e.g., UE1) or by a network node); d. determining the need for transmitting the SLRS based on a pre-defined rule (e.g., UE3 is required to periodically transmit SLRS); and e. determining the need for transmitting the SLRS based on pre-configuration information in the UE (e.g., stored on UE1's SIM/USIM card).

Embodiment 14: The method of any of the previous embodiments wherein determining information related to result of CCA procedure comprises: determining information related to result of CCA procedure based on one or more rules or parameters related to CCA failures associated with the sidelink reference signals transmitted by UE on F1.

Embodiment 15: The method of any of the previous embodiments wherein performing the adaptation transmission of a SL RS comprises: adapting one or more procedures related to or involving the transmission of sidelink reference signals based on the result of CCA procedure determined.

Embodiment 16: The method of any of the previous embodiments wherein adapting one or more procedures comprises one or more of: a. continues transmitting SLRS (e.g. SLSS) on F1; b. if the results of CCA procedures show no CCA failures on F1 or limited number of CCA failures on F1 then the UE may continue transmitting SLRS (e.g. SLSS) according to the reference configuration on F1; c. stops/ceases transmission of the SLRS (e.g. SLSS) on F1 for certain time period; d. if the results of CCA procedures show CCA failures or high number of CCA failures (e.g. number of CCA failures is above a threshold), then UE may stop/cease transmission of SLRS (e.g. SLSS) for a period of time Tn′; e. if (N′>Nmax′) occurs K′ number of times then UE stops/ceases transmission of SLRS (e.g. SLSS); f. if (N′>Nmax′) occurs R1′ number of times during a certain time period (e.g. T0′) then the UE stops/ceases transmissions of SLRS (e.g. SLSS) to UE1 which is using UE as the synchronization reference source; g. suspends or postpones the transmission of the SLRS (e.g. SLSS) on F1 for certain time period; h. if the results of CCA procedures indicate CCA failures or high number of CCA failures (e.g. number of CCA failures is above a threshold), then UE suspends or postpones transmission of SLRS for a period of time Tn′; and i. if the results of CCA procedures indicate CCA failures or high number of CCA failures (e.g. number of CCA failures is above a threshold), then UE adapts one or more transmission parameters of SLRS.

Embodiment 17: The method of any of the previous embodiments, further comprising: providing user data; and forwarding the user data to a host computer via the transmission to the base station.

### Group B Embodiments

Embodiment 18: A method performed by a base station, the method comprising one or more of: the features disclosed herein.

Embodiment 19: The method of the previous embodiment including any of the features from the Group A Embodiments.

Embodiment 20: The method of any of the previous embodiments, further comprising: obtaining user data; and forwarding the user data to a host computer or a wireless device.

### Group C Embodiments

Embodiment 21: A wireless device for selecting and/or maintaining a synchronization source, the wireless device comprising: processing circuitry configured to perform any of the steps of any of the Group A embodiments; and power supply circuitry configured to supply power to the wireless device.

Embodiment 22: A base station, the base station comprising: processing circuitry configured to perform any of the steps of any of the Group B embodiments; and power supply circuitry configured to supply power to the base station.

Embodiment 23: A User Equipment, UE, for selecting and/or maintaining a synchronization source, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 24: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 25: The communication system of the previous embodiment further including the base station.

Embodiment 26: The communication system of the previous 2 embodiments, further including the UE, wherein the UE is configured to communicate with the base station.

Embodiment 27: The communication system of the previous 3 embodiments, wherein: the processing circuitry of the host computer is configured to execute a host application, thereby providing the user data; and the UE comprises processing circuitry configured to execute a client application associated with the host application.

Embodiment 28: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 29: The method of the previous embodiment, further comprising, at the base station, transmitting the user data.

Embodiment 30: The method of the previous 2 embodiments, wherein the user data is provided at the host computer by executing a host application, the method further comprising, at the UE, executing a client application associated with the host application.

Embodiment 31: A User Equipment, UE, configured to communicate with a base station, the UE comprising a radio interface and processing circuitry configured to perform the method of the previous 3 embodiments.

Embodiment 32: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 33: The communication system of the previous embodiment, wherein the cellular network further includes a base station configured to communicate with the UE.

Embodiment 34: The communication system of the previous 2 embodiments, wherein: the processing circuitry of the host computer is configured to execute a host application, thereby providing the user data; and the UE's processing circuitry is configured to execute a client application associated with the host application.

Embodiment 35: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 36: The method of the previous embodiment, further comprising at the UE, receiving the user data from the base station.

Embodiment 37: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 38: The communication system of the previous embodiment, further including the UE.

Embodiment 39: The communication system of the previous 2 embodiments, further including the base station, wherein the base station comprises a radio interface configured to communicate with the UE and a communication interface configured to forward to the host computer the user data carried by a transmission from the UE to the base station.

Embodiment 40: The communication system of the previous 3 embodiments, wherein: the processing circuitry of the host computer is configured to execute a host application; and the UE's processing circuitry is configured to execute a client application associated with the host application, thereby providing the user data.

Embodiment 41: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 42: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 43: The method of the previous embodiment, further comprising, at the UE, providing the user data to the base station.

Embodiment 44: The method of the previous 2 embodiments, further comprising: at the UE, executing a client application, thereby providing the user data to be transmitted; and at the host computer, executing a host application associated with the client application.

Embodiment 45: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 46: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 47: The communication system of the previous embodiment further including the base station.

Embodiment 48: The communication system of the previous 2 embodiments, further including the UE, wherein the UE is configured to communicate with the base station.

Embodiment 49: The communication system of the previous 3 embodiments, wherein: the processing circuitry of the host computer is configured to execute a host application; and the UE is configured to execute a client application associated with the host application, thereby providing the user data to be received by the host computer.

Embodiment 50: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 51: The method of the previous embodiment, further comprising at the base station, receiving the user data from the UE.

Embodiment 52: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 3GPP | Third Generation Partnership Project |
| 5G | Fifth Generation |
| 5GC | Fifth Generation Core |
| 5GS | Fifth Generation System |
| AF | Application Function |
| AMF | Access and Mobility Function |
| AN | Access Network |
| AP | Access Point |
| ASIC | Application Specific Integrated Circuit |
| AUSF | Authentication Server Function |
| CCA | Clear Channel Assessment |
| CPU | Central Processing Unit |
| DCI | Downlink Control Information |
| DN | Data Network |
| DSP | Digital Signal Processor |
| eNB | Enhanced or Evolved Node B |
| EPS | Evolved Packet System |
| E-UTRA | Evolved Universal Terrestrial Radio Access |
| FPGA | Field Programmable Gate Array |
| gNB | New Radio Base Station |
| gNB-DU | New Radio Base Station Distributed Unit |
| GNSS | Global Navigation Satellite System |
| HSS | Home Subscriber Server |
| IoT | Internet of Things |
| IP | Internet Protocol |
| LTE | Long Term Evolution |
| MAC | Medium Access Control |
| MME | Mobility Management Entity |
| MTC | Machine Type Communication |
| NEF | Network Exposure Function |
| NF | Network Function |
| NR | New Radio |
| NRF | Network Function Repository Function |
| NSSF | Network Slice Selection Function |
| OTT | Over-the-Top |
| PC | Personal Computer |
| PCF | Policy Control Function |
| PDSCH | Physical Downlink Shared Channel |
| P-GW | Packet Data Network Gateway |
| PRS | Positioning Reference Signal |
| QoS | Quality of Service |
| RAM | Random Access Memory |
| RAN | Radio Access Network |
| ROM | Read Only Memory |
| RP | Reception Point |
| RRH | Remote Radio Head |
| RS | Reference Signal |
| RTT | Round Trip Time |
| SCEF | Service Capability Exposure Function |
| SL | Sidelink |
| SLRS | Sidelink Reference Signal |
| SLSS | Sidelink Synchronization Signal |
| SMF | Session Management Function |
| SRS | Synchronization Reference Source |
| TCI | Transmission Configuration Indicator |
| TP | Transmission Point |
| TRP | Transmission/Reception Point |
| UDM | Unified Data Management |
| UE | User Equipment |
| UPF | User Plane Function |

Those skilled in the art will recognize improvements and modifications to the embodiments of the present disclosure. All such improvements and modifications are considered within the scope of the concepts disclosed herein.

1. A method performed by a User Equipment (UE), UE, for selecting and/or maintaining a synchronization source, the method comprising:
obtaining information about one or more synchronization sources associated with sidelink operation, the one or more synchronization sources comprising a configured synchronization source and/or available synchronization sources;
for a first synchronization source of the one or more synchronization sources associated with the sidelink operation, determining whether to adapt selecting and/or maintaining of the first synchronization source as a source of synchronization, the determining based on at least one Clear Channel Assessment (CCA) procedure; and
in response to determining to adapt the selecting and/or maintaining of the first synchronization source as the source of synchronization based on the at least one CCA procedure, adapting the selecting and/or maintaining of the first synchronization source as the source of synchronization.

2. The method of claim 1, wherein determining whether to adapt the selecting and/or maintaining of the first synchronization source as the source of synchronization is based on a number of CCA failures.

3. The method of claim 2, wherein determining whether to adapt the selecting and/or maintaining of the first synchronization source as the source of synchronization based on the number of CCA failures comprises:
determining that the number of CCA failures exceeds a maximum value.

4. The method of claim 1, wherein the UE is currently using the first synchronization source as the source of synchronization and wherein adapting the selecting and/or maintaining of the first synchronization source as the source of synchronization comprises continuing to use the first synchronization source as the source of synchronization based on a number of CCA failures being less than a maximum value.

5. The method of claim 1, wherein adapting the selecting and/or maintaining of the first synchronization source as the source of synchronization comprises one or more of:
discarding, suspending, and/or postponing the selecting and/or maintaining of the first synchronization source as the source of synchronization for a certain period of time based on a number of CCA failures being greater than a maximum value.

6. The method of claim 1, wherein adapting the selecting and/or maintaining of the first synchronization source as the source of synchronization comprises:
reselecting another of the one or more synchronization sources associated with the sidelink operation as the source of synchronization.

7. The method of claim 1, wherein adapting the selecting and/or maintaining of the first synchronization source as the source of synchronization comprises one or more of:
after suspending or postponing the selecting and/or maintaining of the first synchronization source as the source of synchronization for a time period, resuming the selecting and/or maintaining of the first synchronization source as the source of synchronization when one or more conditions are met;
resuming the selecting and/or maintaining of the first synchronization source as the source of synchronization when the UE has performed a reselection to a new cell;
adapting the transmission of a sidelink synchronization signal, SLSS, on another carrier frequency based on CCA failures on a first carrier frequency; and
if the at least one CCA procedure indicates that a number of CCA failures on the first carrier frequency exceeds a maximum value for a period of time (Tn), then initiating SLSS transmission on another carrier frequency.

8. The method of claim 1, wherein the obtaining information about the one or more synchronization sources associated with the sidelink operation comprises obtaining the information based on a message received from a network node.

9. The method of claim 1, further comprising the UE selecting the first synchronization source from a set of predefined synchronization sources based on identifiers received from a network node.

10. The method of claim 1, further comprising selecting or using a gNodeB (gNB) or an eNodeB (eNB) as the source of synchronization if the UE is configured with a first identifier that assumes a gNB-based synchronization configuration or an eNB-based synchronization configuration.

11. The method of claim 1, further comprising using a Global Navigation Satellite System (GNSS) as the source of synchronization if the UE is configured with a second identifier.

12. A method performed by a User Equipment (UE) for operating as a synchronization reference UE, the method comprising:
obtaining information related to a need for transmitting a sidelink (SL) reference signal (RS);
determining information related to a result of at least one Clear Channel Assessment (CCA) procedure associated with Synchronization Reference Source (SRS); and
adapting transmission of a SL RS based on the result of the at least one CCA procedure.

13. The method of claim 12, wherein determining information related to a result of at least one CCA procedure is based on a number of CCA failures.

14. The method of claim 10, wherein determining information related to a result of at least one CCA procedure comprises:
determining that the number of CCA failures exceeds a maximum value.

15. The method claim 9, wherein adapting one or more procedures comprises one or more of:
continue transmitting SLRS on the current frequency (F1);
if the results of CCA procedures show no CCA failures on F1 or limited number of CCA failures on F1 then the UE continues transmitting SLRS according to the reference configuration on F1;
stopping/ceasing transmission of the SLRS on F1 for a certain time period;
if the results of CCA procedures show CCA failures or high number of CCA failures, then the UE stops/ceases transmission of SLRS for a period of time (Tn′);
if (N′>Nmax′) occurs K′ number of times, then the UE stops/ceases transmission of SLRS, where N′ is the number of CCA failures, Nmax′ is a threshold value, and K′ is an integer;
if (N′>Nmax′) occurs R1′ number of times during a certain time period, then the UE stops/ceases transmissions of SLRS;
suspending or postponing the transmission of the SLRS on F1 for a certain time period;
if the results of CCA procedures indicate CCA failures or high number of CCA failures, then the UE suspends or postpones transmission of SLRS for a period of time (Tn′); and
if the results of CCA procedures indicate CCA failures or high number of CCA failures, then the UE adapts one or more transmission parameters of SLRS.

16. The method of claim 9, wherein obtaining information related to need for transmitting SLRS comprises one or more of:
obtaining information whether the UE needs to transmit SLRS;
determining the need for transmitting the SLRS if the UE is configured to transmit the SLRS by another node;
determining the need for transmitting the SLRS if UE is configured to transmit the SLRS by another node;
determining the need for transmitting the SLRS based on a pre-defined rule; and
determining the need for transmitting the SLRS based on pre-configuration information in the UE.

17. A User Equipment (UE) comprising processing circuitry and memory, the memory comprising instructions to cause the UE to:
obtain information about one or more synchronization sources associated with sidelink operation, the one or more synchronization sources comprising a configured synchronization source and/or available synchronization sources;
for a first synchronization source of the one or more synchronization sources associated with the sidelink operation, determine whether to adapt selecting and/or maintaining of the first synchronization source as a source of synchronization, the determining based on at least one Clear Channel Assessment (CCA), procedure; and
in response to determining to adapt the selecting and/or maintaining of the first synchronization source as the source of synchronization based on the at least one CCA procedure, adapt the selecting and/or maintaining of the first synchronization source as the source of synchronization.

18. (canceled)

19. A non-transitory computer-readable medium comprising instructions which, when executed on at least one processor, cause the at least one processor to:
obtain information about one or more synchronization sources associated with sidelink operation, the one or more synchronization sources comprising a configured synchronization source and/or available synchronization sources;
for a first synchronization source of the one or more synchronization sources associated with the sidelink operation, determine whether to adapt selecting and/or maintaining of the first synchronization source as a source of synchronization, the determining based on at least one Clear Channel Assessment (CCA) procedure; and
in response to determining to adapt the selecting and/or maintaining of the first synchronization source as the source of synchronization based on the at least one CCA procedure, adapt the selecting and/or maintaining of the first synchronization source as the source of synchronization.

20. A User Equipment (UE) comprising processing circuitry and memory, the memory comprising instructions to cause the UE to:
obtain information related to a need for transmitting a sidelink (SL) reference signal (RS);
determine information related to a result of at least one Clear Channel Assessment (CCA) procedure associated with Synchronization Reference Source (SRS); and
adapt transmission of a SL RS based on the result of the at least one CCA procedure.

21. (canceled)

22. A non-transitory computer-readable medium comprising instructions which, when executed on at least one processor, cause the at least one processor to:
obtain information related to a need for transmitting a sidelink (SL) reference signal (RS);
determine information related to a result of at least one Clear Channel Assessment (CCA) procedure associated with Synchronization Reference Source (SRS); and
adapt transmission of a SL RS based on the result of the at least one CCA procedure.
